(19) United States
(12) Patent Application Publication
(10) Pub. No.: US 2005/0249958 A1
(43) Pub. Date: Nov. 10, 2005

(54) Film-forming compositions substantially free of organic solvent, multi-layer composite coatings and related methods

(76) Inventors: Charles M. Kania, Natrona Heights, PA (US); Roxalana L. Martin, Pittsburgh, PA (US); Carolyn A.K. Novak, Gibsonia, PA (US); Thomas R. Hockswender, Gibsonia, PA (US); Mark A. Tucker, Gibsonia, PA (US); Mary Beth Grolemund, Sarver, PA (US); Deirdre Ragan, Gibsonia, PA (US); Alicia Williams, Greensboro, NC (US); Gina M. Terrago, Pittsburgh, PA (US); Lawrence G. Anderson, Pittsburgh, PA (US)

Correspondence Address: PPG INDUSTRIES, INC.;Intellctual Property - Law Dept., One PPG Place, Pittsburgh, PA, 15272, US

(21) Appl. No.: 10/841,662

(22) Filed: May 7, 2004

(51) Int. Cl. B05D 3/02

(52) U.S. Cl. 428/423.1

(57) ABSTRACT

Film-forming compositions are disclosed that are substantially free of organic solvent. The film-forming compositions include a resinous binder and at least one water dilutable additive including the reaction product of (i) a reactant including at least one isocyanate functional group with (ii) an active hydrogen containing alkoxypolyalkylene compound. Also disclosed are multi-layer composite coatings that include such film-forming compositions and methods of applying such multi-component composite coatings to a substrate.

### CROSS-REFERENCE TO RELATED APPLICATION

This application is related to U.S. patent application Ser. No. ______, entitled, “Organic Solvent-Free Film-Forming Compositions, Multilayer Composite Coatings, and Related Methods”, filed concurrently herewith.

### FIELD OF THE INVENTION

The present invention relates to substantially solvent free film-forming compositions, multi-layer composite coatings comprising such film-forming compositions and methods of applying such multi-component composite coatings to a substrate.

### BACKGROUND INFORMATION

Color-plus-clear coating systems formed from the application of a transparent topcoat over a colored basecoat have become increasingly popular in the coatings industry, particularly for use in coating automobiles. The most economically attractive color-plus-clear systems are those in which the clear coat composition can be applied directly over the uncured colored basecoat. The process of applying one layer of a coating before the previous layer is cured, then simultaneously curing both layers, is referred to as a wet-on-wet (“WOW”) application. Color-plus-clear coating systems suitable for WOW application provide a substantial energy cost savings advantage.

Over the past decade, there has been an effort to reduce atmospheric pollution caused by volatile solvents that are emitted during the painting process. It is, however, often difficult to achieve high quality, smooth coating finishes, particularly clear coating finishes, such as are required in the automotive industry, without including organic solvents which contribute greatly to flow and leveling of a coating. In addition to achieving near-flawless appearance, automotive coatings must be durable and chip resistant, yet economical and easy to apply.

The use of powder coatings to eliminate the emission of volatile solvents during the painting process has become increasingly attractive. Powder coatings have become quite popular for use in coatings for automotive components, for example, wheels, axle parts, seat frames and the like. Use of powder coatings for clear coats in color-plus-clear systems, however, is somewhat less prevalent for several reasons. First, powder coatings require a different application technology than conventional liquid coating compositions and, thus, require expensive modifications to application lines. Also, most automotive topcoat compositions typically are cured at temperatures below 140° C. By contrast, most powder coating formulations require a much higher curing temperature. Further, many powder coating compositions tend to yellow more readily than conventional liquid coating compositions, and generally result in coatings having a high cured film thickness, often ranging from 60 to 70 microns.

Powder coatings in slurry form for automotive coatings can overcome many of the disadvantages of dry powder coatings, however, powder slurry compositions can be unstable and settle upon storage at temperatures above 20° C. Further, WOW application of powder slurry clear coating compositions over conventional basecoats can result in mud-cracking of the system upon curing. See Aktueller Status bei der Pulverlackentwickluna fur die Automobilindustrie am Beispiel fuller und Klarlack, presented by Dr. W. Kries at the 1st International Conference of Car-Body Powder Coatings, Berlin, Germany, Jun. 22-23, 1998, reprinted in Focus on Powder Coatings, The Royal Society of Chemistry, Sep. 2-8, 1998.

Some aqueous dispersions are known to form powder coatings at ambient temperatures. Although applied as conventional waterborne coating compositions, these dispersions form powder coatings at ambient temperature that require a ramped bake prior to undergoing conventional curing conditions in order to effect a coalesced and continuous film on the substrate surface. Also, many waterborne coating compositions contain a substantial amount of organic solvent to provide flow and coalescence of the applied coating.

The automotive industry would derive a significant economic benefit from an essentially organic solvent-free clear coating composition which meets the stringent automotive appearance and performance requirements, while maintaining ease of application and performance properties, such as sag and crater resistance. Also, it would be advantageous to provide an organic solvent-free clear coat composition which can be applied by conventional application means over an uncured pigmented base coating composition (i.e., via WOW application) to form a generally continuous film at ambient temperature which provides a cured film free of mud-cracking.

### SUMMARY OF THE INVENTION

The present invention is directed to film-forming compositions that are substantially free of organic solvent. The film-forming compositions comprise (a) a resinous binder; and (b) at least one water dilutable additive comprising the reaction product of (i) a reactant comprising at least one isocyanate functional group with (ii) an active hydrogen containing alkoxypolyalkylene compound. The present invention is also directed to film-forming compositions that are substantially free of organic solvent, which comprise (a) an aqueous dispersion comprising polymeric microparticles that are adapted to react with a crosslinking agent, (b) at least one water dilutable additive comprising the reaction product of (i) a reactant comprising at least one isocyanate functional group with (ii) an active hydrogen containing alkoxypolyalkylene compound, and (c) at least one water dilutable additive comprising a reactive carboxylic acid functional group-containing polysiloxane.

The present invention is also directed to multi-layer composite coatings. The multi-layer composite coatings of the present invention comprise a basecoat deposited from at least one basecoat film-forming composition and a topcoat composition applied over at least a portion of the basecoat. The topcoat of the multi-layer composite coatings of the present invention is deposited from at least one topcoat film-forming composition that is substantially free of organic solvent, and which comprises (a) a resinous binder; and (b) at least one water dilutable additive comprising the reaction product of (i) a reactant comprising at least one isocyanate functional group with (ii) an active hydrogen containing alkoxypolyalkylene compound.

The present invention is also directed to methods of applying a multi-component composite coating to a substrate. These methods of the present invention comprise the steps of applying to a substrate a film-forming composition from which a basecoat is deposited onto at least a portion of the substrate, and applying onto at least a portion of the basecoat a film-forming composition that is substantially free of organic solvent from which a topcoat is deposited over the basecoat. In accordance with these methods of the present invention, the film-forming composition that is substantially free of organic solvent comprises any of the film-forming compositions of the present invention.

### DETAILED DESCRIPTION OF EMBODIMENTS OF THE INVENTION

For purposes of the following detailed description, it is to be understood that the invention may assume various alternative variations and step sequences, except where expressly specified to the contrary. It is also to be understood that the specific devices and processes are simply exemplary embodiments of the invention. Hence, specific dimensions and other physical characteristics related to the embodiments disclosed herein are not to be considered as limiting. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

It should also be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In certain embodiments of the present invention, the film-forming compositions of the present invention are substantially free of organic solvent and comprise: a resinous binder; and at least one first water dilutable additive comprising the reaction product of (i) a reactant comprising at least one isocyanate functional group with (ii) an active hydrogen containing alkoxypolyalkylene compound. As used herein, the term “substantially free of organic solvent” means that the amount of organic solvent present in the composition is less than 10 weight percent based on total weight of the film-forming composition. In certain particular embodiments, the amount of organic solvent in the composition is less than 5 weight percent, or less than 2 weight percent, based on total weight of the film-forming composition. It should be understood, however, that a small amount of organic solvent can be present in the composition, for example to improve flow and leveling of the applied coating or to decrease viscosity as needed.

As noted above, the film-forming compositions of the present invention include at least one first water dilutable additive comprising the reaction product of (i) a reactant comprising at least one isocyanate functional group with (ii) an active hydrogen containing alkoxypolyalkylene compound. As used herein, the term “water dilutable” means that the additive is or has been adapted to be water soluble or water dispersible.

The isocyanates that are useful as reactant (i) in preparing the first water dilutable additive of the film-forming compositions of the present invention include both monoisocyanates or polyisocyanates, or a mixture thereof. They can be aliphatic or aromatic isocyanates, such as any of those discussed below.

In addition, the polyisocyanates may be prepolymers derived from polyols such as polyether polyols or polyester polyols, including polyols that are reacted with excess polyisocyanates to form isocyanate-terminated prepolymers. Examples of the suitable isocyanate prepolymers are described in U.S. Pat. No. 3,799,854, column 2, lines 22 to 53, which is herein incorporated by reference.

In certain particular embodiments of the present invention, the isocyanate that is used as reactant (i) in preparing the first water dilutable additive of the film-forming compositions of the present invention comprises isophorone diisocyanate.

The active hydrogen containing alkoxypolyalkylenes which are useful as reactant (ii) in preparing the first water dilutable additive of the film-forming compositions of the present invention include alkoxyethylene glycols, such as, for example, methoxypolyethylene glycol and butoxypolyethylene glycol. Also suitable for use as reactant (ii) in preparing the first water dilutable additive of the film-forming compositions of the present invention are polyalkoxyalkylene amines, including polyoxyalkylene monoamines, and polyoxyalkylene polyamines, for example, polyoxyalkylene diamines. Specific non-limiting examples of suitable polyoxyalkylene polyamines include polyoxypropylene diamines commercially available under the tradenames JEFFAMINE® D-2000 and JEFFAMINE® D-400 from Huntsman Corporation of Houston, Tex. Mixed polyoxyalkylene polyamines, that is, those in which the oxyalkylene group can be selected from more than one moiety, also can be used as reactant (ii).

According to certain embodiments of the present invention, the first water dilutable additive is present in the film forming composition in an amount ranging from 0.01 up to 10 percent by weight, or in an amount ranging from 1 up to 8 percent by weight, or, in yet other embodiments, in an amount ranging from 2 up to 7 percent by weight based on total-weight of resin solids present in the film-forming composition. The amount of the first water dilutable additive present in the film forming compositions can range between any combination of the recited values, inclusive of the recited values. It will be understood by those skilled in the art that the amount of the first water dilutable additive present in the film forming composition is determined by the properties desired to be incorporated into the film-forming composition.

In certain embodiments of the present invention, the film-forming composition may include, in addition to or in lieu of the first water dilutable additive, at least one second water dilutable additive which is different from the first water dilutable additive and which comprises a reactive functional group-containing polysiloxane, such as a hydroxyl, carboxylic acid and/or amine functional group-containing polysiloxane.

In accordance with certain embodiments of the present invention, the at least one second water dilutable additive may comprise a carboxylic acid functional group-containing polysiloxane, such as a polysiloxane having the following general structure (I) or (II): 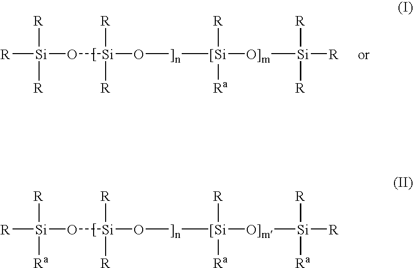
where m is at least 1; m′ is 0 to 50; n is 0 to 50; R is selected from the group consisting of OH and monovalent hydrocarbon groups connected to the silicon atoms; R^{a} has the following structure (III):
R₁—O—X (III)
wherein R₁ is alkylene, oxyalkylene or alkylene aryl; and at least one X contains one or more COOH functional groups.

The acid functional polysiloxane can be prepared, for example, by reacting (a) a polysiloxane polyol; and (b) at least one carboxylic acid functional material or anhydride. The resulting acid functional polyol is further neutralized with, for example, amine, to render the reaction product water dilutable. In accordance with certain embodiments of the present invention, the carboxylic acid functional group-containing polysiloxane is the reaction product of the following reactants: (i) a polysiloxane polyol of the following general formula (IV) or (V): 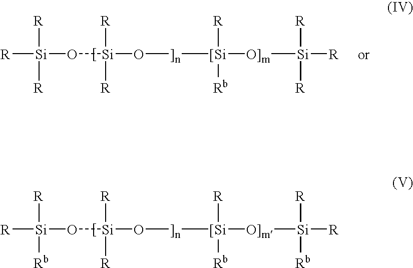
where m is at least 1; m′ is 0 to 50; n is 0 to 50; R is selected from the group consisting of H, OH and monovalent hydrocarbon groups connected to the silicon atoms; and R^{b} has the following structure (VI):
R₁—O—Y (VI)
wherein R₁ is alkylene, oxyalkylene or alkylene aryl; and the moiety Y is H, mono-hydroxy-substituted alkyl or oxyalkyl, or has the structure of CH₂C(R₂)ₐ(R₃)_{b} wherein R₂ is CH₂OH, R₃ is an alkyl group containing from 1 to 4 carbon atoms, a is 2 or 3, and b is 0 or 1; and (ii) at least one polycarboxylic acid or anhydride. The resulting acid functional polyol is further neutralized with, for example, amine, to form the water dilutable additive (c).

Examples of anhydrides suitable for use in the present invention as reactant (ii) immediately above include hexahydrophthalic anhydride, methyl hexahydrophthalic anhydride, phthalic anhydride, trimellitic anhydride, succinic anhydride, chlorendic anhydride, alkenyl succinic anhydride and substituted alkenyl succinic anhydride, and mixtures thereof.

According to certain embodiments of the present invention, the second water dilutable additive can be present in the film forming compositions in an amount ranging from 0.1 up to 10.0 weight percent based on total weight resin solids present in the film-forming composition, or in an amount ranging from 0.1 up to 5.0 weight percent or, in yet other embodiments, in an amount ranging from 0.1 to 1.0 weight percent based on the weight of total solids present in the film-forming composition.

As previously mentioned, the film-forming compositions of the present invention comprise, in addition to the first water dilutable additive and/or the second water dilutable additive, a resinous binder. In certain embodiments of the present invention, the resinous binder present in the film-forming composition comprises (1) at least one reactive functional group-containing polymer, and (2) at least one crosslinking agent having functional groups reactive with the functional groups of the polymer. The polymer (1) can comprise any of a variety of reactive group-containing polymers well known in the surface coatings art provided the polymer is sufficiently dispersible in aqueous media. Suitable non-limiting examples can include, without limitation, acrylic polymers, polyester polymers, polyurethane polymers, polyether polymers, polysiloxane polymers, polyepoxide polymers, copolymers thereof, and mixtures thereof. Also, the polymer (1) may comprise a variety of reactive functional groups such as, for example, functional groups selected from at least one of hydroxyl groups, carboxyl groups, amino groups, amido groups, carbamate groups, isocyanate groups, and combinations thereof.

Suitable hydroxyl group-containing polymers include, for example, acrylic polyols, polyester polyols, polyurethane polyols, polyether polyols, and mixtures thereof. In certain embodiments of the present invention, the polymer (1) comprises an acrylic polyol having an hydroxyl equivalent weight ranging from 1000 to 100 grams per solid equivalent, or, in certain embodiments, 500 to 150 grams per solid equivalent.

In the embodiments of the present invention wherein the polymer (1) is an acrylic polymer, suitable hydroxyl group and/or carboxyl group-containing acrylic polymers can be prepared from polymerizable ethylenically unsaturated monomers and are often copolymers of (meth)acrylic acid and/or hydroxyalkyl esters of (meth)acrylic acid with one or more other polymerizable ethylenically unsaturated monomers, such as alkyl esters of (meth)acrylic acid, including methyl(meth)acrylate, ethyl (meth)acrylate, butyl(meth)acrylate and 2-ethyl hexylacrylate, and vinyl aromatic compounds, such as styrene, alpha-methyl styrene, and vinyl toluene. As used herein, “(meth)acrylic” and terms derived therefrom are intended to include both acrylic and methacrylic.

In the embodiments of the present invention wherein the polymer (1) is an acrylic polymer, the polymer may, for example, be prepared from ethylenically unsaturated, beta-hydroxy ester functional monomers. Such monomers may, for example, be derived from the reaction of an ethylenically unsaturated acid functional monomer, such as a monocarboxylic acid, e.g., acrylic acid, and an epoxy compound which does not participate in the free radical initiated polymerization with such unsaturated acid functional monomer. Non-limiting examples of such epoxy compounds include glycidyl ethers and esters. Suitable glycidyl ethers include, for example, glycidyl ethers of alcohols and phenols, such as butyl glycidyl ether, octyl glycidyl ether, phenyl glycidyl ether, and the like. Suitable glycidyl esters include, for example, those commercially available from Shell Chemical Company under the tradename CARDURA E; and from Exxon Chemical Company under the tradename GLYDEXX-10. Alternatively, the beta-hydroxy ester functional monomers can be prepared from an ethylenically unsaturated, epoxy functional monomer, such as, for example, glycidyl(meth)acrylate and allyl glycidyl ether, and a saturated carboxylic acid, such as, for example, a saturated monocarboxylic acid, such as, for example, isostearic acid.

In the embodiments of the present invention wherein the polymer (1) is an acrylic polymer, epoxy functional groups can be incorporated into the polymer prepared from polymerizable ethylenically unsaturated monomers by copolymerizing oxirane group-containing monomers, such as, for example, glycidyl(meth)acrylate and allyl glycidyl ether, with other polymerizable ethylenically unsaturated monomers, such as those described above. Preparation of such epoxy functional acrylic polymers is described in detail in U.S. Pat. No. 4,001,156 at columns 3 to 6, which is incorporated herein by reference.

In the embodiments of the present invention wherein the polymer (1) is an acrylic polymer, carbamate functional groups may be incorporated into the acrylic polymer prepared from polymerizable ethylenically unsaturated monomers by copolymerizing, for example, the above-described ethylenically unsaturated monomers, with a carbamate functional vinyl monomer such as, for example, a carbamate functional alkyl ester of methacrylic acid. Useful carbamate functional alkyl esters can be prepared, for example, by reacting a hydroxyalkyl carbamate, such as, for example, the reaction product of ammonia and ethylene carbonate or propylene carbonate, with methacrylic anhydride. Other useful carbamate functional vinyl monomers include, for example, the reaction product of hydroxyethyl methacrylate, isophorone diisocyanate, and hydroxypropyl carbamate; or the reaction product of hydroxypropyl methacrylate, isophorone diisocyanate, and methanol. Still other carbamate functional vinyl monomers may be used, such as the reaction product of isocyanic acid (HNCO) with a hydroxyl functional acrylic or methacrylic monomer such as hydroxyethyl acrylate, and those described in U.S. Pat. No. 3,479,328, incorporated herein by reference. Carbamate functional groups can also be incorporated into the acrylic polymer by reacting a hydroxyl functional acrylic polymer with a low molecular weight alkyl carbamate such as methyl carbamate. In addition, pendant carbamate groups can be incorporated into the acrylic polymer by a “transcarbamoylation” reaction in which a hydroxyl functional acrylic polymer is reacted with a low molecular weight carbamate derived from an alcohol or a glycol ether. The carbamate groups exchange with the hydroxyl groups yielding the carbamate functional acrylic polymer and the original alcohol or glycol ether. Also, hydroxyl functional acrylic polymers can be reacted with isocyanic acid to provide pendent carbamate groups. The production of isocyanic acid is disclosed in U.S. Pat. No. 4,364,913, which is incorporated herein by reference. Likewise, hydroxyl functional acrylic polymers can be reacted with urea to provide pendent carbamate groups.

The polymers prepared from polymerizable ethylenically unsaturated monomers may, for example, be prepared by solution polymerization techniques, which are well-known to those skilled in the art, in the presence of suitable catalysts such as organic peroxides or azo compounds, for example, benzoyl peroxide or N,N-azobis(isobutylronitrile). The polymerization can be carried out in an organic solution in which the monomers are soluble by techniques conventional in the art. Alternatively, these polymers can be prepared by aqueous emulsion or dispersion polymerization techniques that are well-known in the art. The ratio of reactants and reaction conditions are selected to result in an acrylic polymer with the desired pendent functionality.

As mentioned earlier, polyester polymers are also useful as polymer (1) in the film-forming compositions of the present invention. In these embodiments, useful polyester polymers often include the condensation products of polyhydric alcohols and polycarboxylic acids. Suitable polyhydric alcohols can include, for example, ethylene glycol, neopentyl glycol, trimethylol propane, and pentaerythritol. Suitable polycarboxylic acids can include, for example, adipic acid, 1,4-cyclohexyl dicarboxylic acid, and hexahydrophthalic acid. Besides the polycarboxylic acids mentioned above, functional equivalents of the acids such as anhydrides where they exist or lower alkyl esters of the acids such as the methyl esters can be used. Also, small amounts of monocarboxylic acids such as stearic acid can be used. The ratio of reactants and reaction conditions are selected to result in a polyester polymer with the desired pendent functionality, i.e., carboxyl or hydroxyl functionality.

For example, hydroxyl group-containing polyesters can be prepared by reacting an anhydride of a dicarboxylic acid such as hexahydrophthalic anhydride with a diol such as neopentyl glycol in a 1:2 molar ratio. Where it is desired to enhance air-drying, suitable drying oil fatty acids may be used and include those derived from linseed oil, soya bean oil, tall oil, dehydrated castor oil, or tung oil.

Carbamate functional polyesters can be prepared by first forming a hydroxyalkyl carbamate that can be reacted with the polyacids and polyols used in forming the polyester. Alternatively, terminal carbamate functional groups can be incorporated into the polyester by reacting isocyanic acid with a hydroxy functional polyester. Also, carbamate functionality can be incorporated into the polyester by reacting a hydroxyl polyester with a urea. Additionally, carbamate groups can be incorporated into the polyester by a transcarbamoylation reaction. Preparation of suitable carbamate functional group-containing polyesters include, for example, those described in U.S. Pat. No. 5,593,733 at column 2, line 40 to column 4, line 9, incorporated herein by reference.

As mentioned above, polyurethane polymers containing terminal isocyanate or hydroxyl groups also can be used as the polymer (1) in the film-forming compositions of the present invention. In these embodiments, the polyurethane polyols or NCO-terminated polyurethanes that can be used include, for example, those prepared by reacting polyols including polymeric polyols with polyisocyanates. Polyureas containing terminal isocyanate or primary and/or secondary amine groups that also can be used are those prepared by reacting polyamines including polymeric polyamines with polyisocyanates. The hydroxyl/isocyanate or amine/isocyanate equivalent ratio is adjusted and reaction conditions are selected to obtain the desired terminal groups. Examples of suitable polyisocyanates include, for example, those described in U.S. Pat. No. 4,046,729 at column 5, line 26 to column 6, line 28, incorporated herein by reference. Examples of suitable polyols include, for example, those described in U.S. Pat. No. 4,046,729 at column 7, line 52 to column 10, line 35, incorporated herein by reference. Examples of suitable polyamines include, for example, those described in U.S. Pat. No. 4,046,729 at column 6, line 61 to column 7, line 32 and in U.S. Pat. No. 3,799,854 at column 3, lines 13 to 50, both incorporated herein by reference.

In the embodiments of the present invention wherein the polymer (1) is a polyurethane polymer, carbamate functional groups may be incorporated into the polyurethane polymer by reacting a polyisocyanate with a polyester having hydroxyl functionality and containing pendent carbamate groups. Alternatively, the polyurethane can be prepared by reacting a polyisocyanate with a polyester polyol and a hydroxyalkyl carbamate or isocyanic acid as separate reactants. Examples of suitable polyisocyanates include aromatic isocyanates, such as 4,4′-diphenylmethane diisocyanate, 1,3-phenylene diisocyanate and toluene diisocyanate, and aliphatic polyisocyanates, such as, for example, 1,4-tetramethylene diisocyanate and 1,6-hexamethylene diisocyanate. Cycloaliphatic diisocyanates, such as, for example, 1,4-cyclohexyl diisocyanate and isophorone diisocyanate also can be employed.

Examples of suitable polyether polyols include polyalkylene ether polyols such as those having the following structural formula (VII): 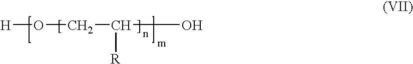
wherein the substituent R is hydrogen or a lower alkyl group containing from 1 to 5 carbon atoms including mixed substituents, and n has a value typically ranging from 2 to 6 and m has a value ranging from 8 to 100 or higher. Exemplary polyalkylene ether polyols include, for example, poly(oxytetramethylene)glycols, poly(oxytetraethylene)glycols, poly(oxy-1,2-propylene)glycols, and poly(oxy-1,2-butylene)glycols.

Also useful are polyether polyols formed from oxyalkylation of various polyols, for example, glycols such as ethylene glycol, 1,6-hexanediol, Bisphenol A, and the like, or other higher polyols such as trimethylolpropane, pentaerythritol, and the like. Polyols of higher functionality can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Specific examples of polyethers include those sold under the names TERATHANE and TERACOL, available from E. I. Du Pont de Nemours and Company, Inc.

Generally, the polymers having reactive functional groups which are useful in the film-forming compositions of the present invention can have a weight average molecular weight (Mw) typically ranging from 1-000 to 20,000, or from 1500 to 15,000 or from 2000 to 12,000 as determined by gel permeation chromatography using a polystyrene standard.

In certain embodiments of the present invention, the resinous binder present in the film-forming compositions of the present invention comprises an aqueous dispersion comprising polymeric microparticles that are adapted to react with a crosslinking agent. As used herein, the term “dispersion” means that the microparticles are capable of being distributed throughout water as finely divided particles, such as a latex. See Hawley's Condensed Chemical Dictionary, (12th Ed. 1993) at page 435, which is hereby incorporated by reference. The uniformity of the dispersion can be increased by the addition of wetting, dispersing or emulsifying agents (surfactants). In certain embodiments of the invention, the amount of the dispersion resin solids present in the film-forming composition may be forming at least 20 weight percent, or, in some embodiments, from at least 30 weight percent, or, in yet other embodiments, from at least 40 weight percent based on the total resin solids weight of the film-forming composition. In certain embodiments of the invention, the amount of the dispersion resin solids present in the film-forming composition also can be no more than 90 weight percent, or, in some embodiments, no more than 85 weight percent, or, in yet other embodiments, no more than 80 weight percent based on the total resin solids weight of the film-forming composition. The amount of the dispersion of polymeric microparticles present in the film-forming composition can range between any combination of these values inclusive of the recited values. The solids content is determined by heating a sample of the composition to 105° to 110° C. for 1-2 hours to drive off the volatile material, and subsequently measuring relative weight loss.

In certain embodiments of the present invention, the resinous binder comprises an aqueous dispersion of polymeric microparticles prepared from (i) at least one polymer having reactive functional groups, typically a substantially hydrophobic polymer; and (ii) at least one crosslinking agent, typically a substantially hydrophobic crosslinking agent, containing functional groups that are reactive with the functional groups of the polymer. Suitable substantially hydrophobic polymers can be prepared by polymerizing one or more ethylenically unsaturated carboxylic acid functional group-containing monomers and one or more other ethylenically unsaturated monomers free of acid functionality, e.g., an ethylenically unsaturated monomer having hydroxyl and/or carbamate functional groups. Suitable substantially hydrophobic crosslinking agents can include, for example, polyisocyanates, blocked polyisocyanates and aminoplast resins. Suitable aqueous dispersions of polymeric microparticles and the preparation thereof include those described in detail in U.S. Pat. No. 6,462,139 at column 4, line 17 to column 11, line 49, which is incorporated herein by reference.

As used herein, the term “substantially hydrophobic” means that the hydrophobic component is essentially not compatible with, does not have an affinity for and/or is not capable of dissolving in water using conventional mixing means. That is, upon mixing a sample of the hydrophobic component with an organic component and water, a majority of the hydrophobic component is in the organic phase and a separate aqueous phase is observed. See Hawley's Condensed Chemical Dictionary, (12th ed. 1993) at page 618.

In certain embodiments of the present invention, the resinous binder comprises an aqueous dispersion of polymeric microparticles prepared from (1) one or more reaction products of ethylenically unsaturated monomers, at least one of which contains at least one acid functional group, (2) one or more polymers different from (1) and (3), typically containing reactive functional groups, which are typically substantially hydrophobic polymers, and (3) one or more crosslinking agents, typically substantially hydrophobic crosslinking agents, having functional groups reactive with those of the reaction product (1) and/or the polymer (2). The polymer (2) can be any of the well-known polymers such as acrylic polymers, polyester polymers, alkyd polymers, polyurethane polymers, polyether polymers, polyurea polymers, polyamide polymers, polycarbonate polymers, copolymers thereof and mixtures thereof. Suitable substantially hydrophobic crosslinking agents include, for example, those identified above. Suitable aqueous dispersions of polymeric microparticles and the preparation thereof include those described in detail in U.S. Pat. No. 6,329,060 at column 4, line 27 to column 17, line 6, which is incorporated herein by reference.

In certain embodiments of the present invention, the resinous binder comprises an aqueous dispersion of polymeric microparticles prepared from components (A) at least one functional group-containing reaction product of polymerizable, ethylenically unsaturated monomers; and (B) at least one reactive organopolysiloxane. The components from which the polymeric microparticles can be prepared may further include (C) at least one substantially hydrophobic crosslinking agent. The reactive organopolysiloxane (B) typically comprises at least one of the following structural units (VIII):
R¹ₙR²ₘ—(—Si—O)_{(4-n-m)/2} (VIII)
where m and n each represent a positive number fulfilling the requirements of: 0<n<4; 0<m<4; and 2≦(m+n)<4; R¹ represents H, OH or monovalent hydrocarbon groups; and R² represents a monovalent reactive functional group-containing organic moiety. In certain embodiments of the present invention, R² represents a reactive group-containing moiety selected from at least one of hydroxyl, carboxylic acid, isocyanate and blocked isocyanate, primary amine, secondary amine, amide, carbamate, urea, urethane, alkoxysilane, vinyl and epoxy functional groups. Suitable aqueous dispersions of polymeric microparticles and the preparation thereof include those described in detail in U.S. Pat. No. 6,387,997 at column 3, line 47 to column 14, line 54, which is incorporated herein by reference.

In certain embodiments of the present invention, the film-forming composition may also comprise one or more crosslinking agents that are adapted to react with the functional groups of the polymer and/or polymeric microparticles and/or other components in the composition to provide curing, if desired, for the film-forming composition. Non-limiting examples of suitable crosslinking agents include any of the amihoplasts and polyisocyanates generally known in the art of surface coatings, provided that the crosslinking agent(s) are adapted to be water soluble or water dispersible as described below, and polyacids, polyanhydrides and mixtures thereof. When used, this additional crosslinking agent or mixture of crosslinking agents is dependent upon the functionality associated with the polymer and/or polymeric microparticles present in the composition, such as hydroxyl and/or carbamate functionality. When, for example, the functionality is hydroxyl, the crosslinking agent may comprise an aminoplast or polyisocyanate crosslinking agent.

Examples of suitable aminoplast resins include those containing methylol or similar alkylol groups, a portion of which have been etherified by reaction with a lower alcohol, such as methanol, to provide a water soluble/dispersible aminoplast resin. One appropriate aminoplast resin is the partially methylated aminoplast resin, CYMEL 385, which is commercially available from Cytec Industries, Inc. An example of a suitable blocked isocyanate which is water soluble/dispersible is dimethylpyrazole blocked hexamethylene diisocyanate trimer commercially available as BI 7986 from Baxenden Chemicals, Ltd. in Lancashire, England.

Polyacid crosslinking materials suitable for use as a crosslinking agent in the present invention include, for example, those that on average generally contain greater than one acid group per molecule, sometimes three or more and sometimes four or more, such acid groups being reactive with epoxy functional film-forming polymers. Polyacid crosslinking materials may have di-, tri- or higher functionalities. Suitable polyacid crosslinking materials which can be used include, for example, carboxylic acid group-containing oligomers, polymers and compounds, such as acrylic polymers, polyesters, and polyurethanes and compounds having phosphorus-based acid groups.

Examples of suitable polyacid crosslinking agents include, for example, ester group-containing oligomers and compounds including half-esters formed from reacting polyols and cyclic 1,2-acid anhydrides or acid functional polyesters derived from polyols and polyacids or anhydrides. These half-esters are of relatively low molecular weight and are quite reactive with epoxy functionality. Suitable ester group-containing oligomers include those described in U.S. Pat. No. 4,764,430, column 4, line 26 to column 5, line 68, which is hereby incorporated by reference.

Other useful crosslinking agents include acid-functional acrylic crosslinkers made by copolymerizing methacrylic acid and/or acrylic acid monomers with other ethylenically unsaturated copolymerizable monomers as the polyacid crosslinking material. Alternatively, acid-functional acrylics can be prepared from hydroxy-functional acrylics reacted with cyclic anhydrides.

In accordance with certain embodiments of the present invention, the crosslinking agent, which typically is water soluble and/or water dispersable, may be present as a component in the film-forming composition in an amount ranging from 0 to at least 10 percent by weight, or at least 10 to at least 20 percent by weight, or from at least 20 to at least 30 percent by weight, based on total resin solids weight in the film-forming composition. In accordance with certain embodiments of the present invention such a crosslinking agent may be present in the film-forming composition in an amount ranging from less than or equal to 70 to less than or equal to 60 percent by weight, or less than or equal to 60 to less than or equal to 50 percent by weight, or less than or equal to 50 to less than or equal to 40 percent by weight, based on total resin solids weight of the film-forming composition. Such a crosslinking agent can be present in the film-forming composition in an amount ranging between any combination of these values inclusive of the recited values.

In certain embodiments of the present invention, the film-forming composition may further comprise, in addition to or in lieu of the aqueous dispersion of polymeric microparticles described above, an aqueous dispersion of polymeric microparticles prepared by emulsion polymerization of a monomeric composition comprising (1) at least 10 percent by weight of one or more vinyl aromatic compounds; (2) 0.1 to 10 percent by weight of one or more carboxylic acid functional polymerizable, ethylenically unsaturated monomers; (3) 0 to 10 percent by weight of one or more polymerizable monomers having one or more functional groups which are capable of reacting to form crosslinks; and (4) one or more polymerizable ethylenically unsaturated monomers, where the weight percentages are based on total weight of monomers present in the monomeric composition. Each of (1), (2), (3) and (4) above is different one from the other, and at least one of (3) and (4) is present in such a monomeric composition. As used herein, the phrase, “different one from the other” refers to components that do not have the same chemical structure as the other components in the composition. As used herein, the phrase “second polymeric microparticles” refers to the polymeric microparticles prepared as described in this paragraph.

The vinyl aromatic compound (1) from which the second polymeric microparticles are prepared can comprise any suitable vinyl aromatic compound known in the art. The one or more vinyl-aromatic compounds (1) can comprise, for example, a compound selected from styrene, alph-methyl styrene, vinyl toluene, para-hydroxy styrene and mixtures thereof.

The vinyl aromatic compound (1) can be present in the monomeric composition from which the second polymeric microparticles are prepared in an amount of at least 10 percent by weight, or at least 20 percent by weight, or at least 30 percent by weight, or at least 40 percent by weight, based on total weight of monomers present in the monomeric composition. The vinyl aromatic compound (1) also can be present in the monomeric composition from which the second polymeric microparticles are prepared in an amount of not more than 98 percent by weight, or not more than 80 percent by weight, or not more than 70 percent by weight, or not more than 60 percent by weight, based on total weight of monomers present in the monomeric composition. The amount of vinyl aromatic compound (1) present in the monomeric composition from which the second polymeric microparticles are prepared can range between any combination of the recited values, inclusive of the recited values. It will be understood by those skilled in the art that the amount of the vinyl aromatic compound (1) used to prepare the second polymeric microparticles is determined by the properties desired to be incorporated into the second polymeric microparticles and/or the compositions containing such microparticles.

The one or more carboxylic acid functional, polymerizable, ethylenically unsaturated monomers (2) from which the second polymeric microparticles are prepared can comprise any of the ethylenically unsaturated carboxylic acid functional monomers known in the art, including, where applicable, anhydrides thereof. The carboxylic acid functional, polymerizable, ethylenically unsaturated monomer (2) can comprise, for example, one or more monomers selected from acrylic acid, methacrylic acid, itaconic acid, fumaric acid, maleic acid, anhydrides thereof (where applicable) and mixtures thereof. Non-limiting examples of anhydrides suitable for use as the one or more carboxylic acid functional, polymerizable, ethylenically unsaturated monomers (2) include maleic anhydride, fumaric anhydride, itaconic anhydride, methacrylic anhydride, and mixtures thereof.

The one or more carboxylic acid functional, polymerizable, ethylenically unsaturated monomers (2) can be present in the monomeric composition from which the second polymeric microparticles are prepared in an amount of 0 percent by weight, or at least 0.5 percent by weight, or at least 1 percent by weight, based on total weight of monomers present in the monomeric composition. The carboxylic acid functional, polymerizable, ethylenically unsaturated monomer (2) also can be present in the monomeric composition from which the polymeric microparticles are prepared in an amount of not more than 10 percent by weight, or not more than 8 percent by weight, or not more than 5 percent by weight, based on total weight of monomers present in the monomeric composition. The amount of the one or more carboxylic acid functional, polymerizable, ethylenically unsaturated monomers (2) present in the monomeric composition from which the second polymeric microparticles are prepared can range between any combination of the recited values, inclusive of the recited values. It will be understood by those skilled in the art that the amount of the one or more carboxylic acid functional, polymerizable, ethylenically unsaturated monomers (2) used to prepare the second polymeric microparticles is determined by the properties desired to be incorporated into the second polymeric microparticles and/or the compositions containing such microparticles.

The one or more polymerizable monomer(s) (3) having one or more functional groups that are capable of reacting to form crosslinks from which the second polymeric microparticles are prepared can include any of the art recognized polymerizable monomers that have reactive functional groups capable of reacting either during the polymerization process with a mutually reactive functional group(s) present on any of the other monomers present in the monomeric composition, or, alternatively, after the monomer has been polymerized, for example, with mutually reactive functional groups present on one or more of the film-forming composition components. As used herein, “functional groups that are capable of reacting to form crosslinks after polymerization” refer to, for example, functional groups on a first polymer molecule that may react under appropriate conditions to form covalent bonds with mutually reactive functional groups on a second polymer molecule, for example a crosslinking agent molecule, or different polymer molecules present in the film-forming composition.

In certain embodiments of the present invention, the one or more polymerizable monomers (3) having functional groups capable of reacting to form crosslinks from which the second polymeric microparticles are prepared may comprise any of a variety of reactive functional groups including, but not limited to, those selected from amide groups, hydroxyl groups, amino groups, epoxy groups, thiol groups, isocyanate groups, carbamate groups, and mixtures thereof.

In addition, the one or more polymerizable monomers (3) from which the second polymeric microparticles are prepared can comprise a compound selected from N-alkoxymethyl amides, N-methylolamides, lactones, lactams, mercaptans, hydroxyls, epoxides, and the like. Examples of such monomers include, but are not limited to y-(meth)acryloxytrialkoxysilane, N-methylol(meth)acrylamide, N-butoxymethyl(meth)acrylamide, (meth)acryliclactones, N-substituted (meth)acrylamide lactones, (meth)acryliclactams, N-substituted (meth)acrylamide lactams, glycidyl (meth)acrylate, allyl glycidyl ether, and mixtures thereof.

The one or more polymerizable monomers (3) can be present in the monomeric composition from which the second polymeric microparticles are prepared in an amount of 0 percent by weight, or at least 0.5 percent by weight, or at least 1 percent by weight, based on total weight of monomers present in the monomeric composition. The one or more polymerizable monomers (3) also can be present in the monomeric composition from which the second polymeric microparticles are prepared in an amount of not more than 10 weight percent, or not more than 8 percent by weight, or not more than 5 percent by weight, based on total weight of monomers present in the monomeric composition. The amount of the one or more polymerizable monomers (3) present in the monomeric composition from which the second polymeric microparticles are prepared can range between any combination of the recited values, inclusive of the recited values. It will be understood by those skilled in the art that the amount of the one or more polymerizable monomers (3) used to prepare the second polymeric microparticles is determined by the properties desired to be incorporated into the second polymeric microparticles and/or the film-forming compositions containing such microparticles.

The one or more polymerizable ethylenically unsaturated monomer (4) from which the second polymeric microparticles are prepared can be any of the art recognized ethylenically unsaturated monomers, provided that the polymerizable ethylenically unsaturated monomer (4) is different from any of the aforementioned monomers (1), (2), and (3). Polymerizable ethylenically unsaturated monomers suitable for use as the monomer (4) which, optionally, make up the remainder of the monomeric composition used to prepare the second polymeric microparticles, and which are different from the monomers (1), (2) and (3), may include any suitable polymerizable ethylenically unsaturated monomer capable of being polymerized in a emulsion polymerization system and does not substantially affect the stability of the emulsion or the polymerization process.

Suitable polymerizable ethylenically unsaturated monomers include, but are not limited to, alkyl esters of (meth)acrylic acid such as methyl(meth)acrylate, ethyl(meth)acrylate, propyl(meth)acrylate, N-butyl(meth)acrylate, t-butyl(meth)acrylate, 2-ethylhexyl(meth)acrylate, isobornyl (meth)acrylate, lauryl(meth)acrylate, cyclohexyl(meth)acrylate, and 3,3,5-trimethylcyclohexyl(meth)acrylate.

The one or more polymerizable ethylenically unsaturated monomers (4) from which the second polymeric microparticles are prepared also can include hydroxy-functional ethylenically unsaturated monomers, for example, a compound selected from hydroxyethyl(meth)acrylate, hydroxybutyl(meth)acrylate, hydroxypropyl(meth)acrylate, dimethylaminoethyl (meth)acrylate, allyl glycerol ether, methallyl glycerol ether, and mixtures thereof.

In certain embodiments of the present invention, the one or more polymerizable ethylenically unsaturated monomers (4) from which the second polymeric microparticles are prepared can comprise one or more ethylenically unsaturated, beta-hydroxy ester functional monomers. Such monomers can be derived from the reaction of an ethylenically unsaturated acid functional monomer, such as any of the monocarboxylic acids described above, e.g., acrylic acid, and an epoxy compound which does not participate in the free radical initiated polymerization with such unsaturated acid functional monomer. Examples of such epoxy compounds include glycidyl ethers and esters. Suitable glycidyl ethers include glycidyl ethers of alcohols and phenols such as butyl glycidyl ether, octyl glycidyl ether, phenyl glycidyl ether and the like. Suitable glycidyl esters include those commercially available from Shell Chemical Company under the tradename CARDURA E; and from Exxon Chemical Company under the tradename GLYDEXX-10. Alternatively, the beta-hydroxy ester functional monomers can be prepared from an ethylenically unsaturated, epoxy functional monomer, for example glycidyl(meth)acrylate and allyl glycidyl ether, and a saturated carboxylic acid, such as a saturated monocarboxylic acid, for example isostearic acid.

The one or more ethylenically unsaturated polymerizable monomers (4) can be present in the monomeric composition from which the second polymeric microparticles are prepared in an amount of 0 percent by weight, or at least 0.5 percent by weight, or at least 1 percent by weight, or at least 10 weight percent, or at least 20 weight percent based on total weight of monomers present in the monomeric composition. The one or more ethylenically unsaturated polymerizable monomers (4) also can be present in the monomeric composition from which the second polymeric microparticles are prepared in an amount of not more than 60 percent by weight, or not more than 50 percent by weight, or not more than 45 percent by weight, or not more than 40 percent by weight, based on total weight of monomers present in the monomeric composition. The amount of the one or more ethylenic ally unsaturated polymerizable monomers (4) present in the monomeric composition from which the second polymeric microparticles are prepared can range between any combination of the recited values, inclusive of the recited values. It will be understood by those skilled in the art that the amount of the one or more ethylenically unsaturated polymerizable monomers (4) used to prepare the second polymeric microparticles is determined by the properties desired to be incorporated into the second polymeric microparticles and/or the film-forming compositions comprising such microparticles.

The one or more ethylenically unsaturated polymerizable monomers (4) from which the second polymeric microparticles are prepared may comprise a crosslinking monomer having two or more sites of reactive unsaturation, or any of the previously mentioned monomers having functional groups capable of reacting to form a crosslink after polymerization. Suitable monomers having two or more sites of reactive unsaturation can include, but are not limited to, one or more of ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, glycerol allyloxy di(meth)acrylate, 1,1,1-tris(hydroxymethyl)ethane di(meth)acrylate, 1,1,1-tris(hydroxymethyl)ethane tri(meth)acrylate, 1,1,1-tris(hydroxymethyl)propane di(meth)acrylate, 1,1,1-tris(hydroxymethyl)propane tri(meth)acrylate, triallyl cyanurate, triallyl isocyanurate, triallyl trimellitate, diallyl phthalate, diallyl terephthalte, divinyl benzene, methylol (meth)acrylamide, triallylamine, and methylenebis(meth)acrylamide.

As mentioned above, the aqueous dispersion of second polymeric microparticles, if present, is prepared by well-known emulsion polymerization techniques. For example the monomeric composition may be prepared by admixing monomers (1), with monomers (2); and/or (3) and/or (4). The monomeric composition is dispersed in the aqueous continuous phase under high shear to form stable monomer droplets and/or micelles as would be expected under typical emulsion polymerization techniques. Emulsifiers, protective colloids, and/or surface active agents as are well known in the art may be included to stabilize or prevent coagulation or agglomeration of the monomer droplets during the polymerization process. The aqueous dispersion of second polymeric microparticles is then subjected to radical polymerization conditions to polymerize the monomers within the droplets or micelles.

Suitable emulsifiers and protective colloids include, but are not limited to, high molecular weight polymers such as hydroxyethyl cellulose, methyl cellulose, polyacrylic acid, polyvinyl alcohol, and the like. Also, materials such as base-neutralized acid functional polymers can be employed for this purpose. Suitable surface active agents include any of the well known anionic, cationic or nonionic surfactants or dispersing agents. Mixtures of such materials can be used in the aqueous dispersion of second polymeric microparticles.

Suitable cationic dispersion agents that may be used with the aqueous dispersion of second polymeric microparticles include, but are not limited to, lauryl pyridinium chloride, cetyldimethyl amine acetate, and alkyldimethylbenzylammonium chloride, in which the alkyl group has from 8 to 18 carbon atoms. Suitable anionic dispersing agents include, but are not limited to alkali fatty alcohol sulfates, such as sodium lauryl sulfate, and the like; arylalkyl sulfonates, such as potassium isopropylbenzene sulfonate, and the like; alkali alkyl sulfosuccinates, such as sodium octyl sulfosuccinate, and the like; and alkali arylalkylpolyethoxyethanol sulfates or sulfonates, such as sodium octylphenoxypolyethoxyethyl sulfate, having 1 to 5 oxyethylene units, and the like. Suitable non-ionic surface active agents include but are not limited to, alkyl phenoxypolyethoxy ethanols having alkyl groups of from about 7 to 18 carbon atoms and from about 6 to about 60 oxyethylene units such as, for example, heptyl phenoxypolyethoxyethanols; ethylene oxide derivatives of long chained carboxylic acids such as lauric acid, myristic acid, palmitic acid, oleic acid, and the like, or mixtures of acids such as those found in tall oil containing from 6 to 60 oxyethylene units; ethylene oxide condensates of long chained alcohols such as octyl, decyl, lauryl, or cetyl alcohols containing from 6 to 60 oxyethylene units; ethylene oxide condensates of long-chain or branched chain amines such as dodecyl amine, hexadecyl amine, and octadecyl amine, containing from 6 to 60 oxyethylene units; and block copolymers of ethylene oxide sections combined with one or more hydrophobic propylene oxide sections.

A free radical initiator typically is used in the emulsion polymerization process. Any suitable free radical initiator may be used. Suitable free radical initiators include, but are not limited to, thermal initiators, photinitiators and oxidation-reduction initiators, all of which may be otherwise categorized as being water-soluble initiators or non-water-soluble initiators. Examples of thermal initiators include, but are not limited to, azo compounds, peroxides and persulfates. Suitable persulfates include, but are not limited to, sodium persulfate and ammonium persulfate. Oxidation-reduction initiators may include, as non-limiting examples, persulfate-sullfite systems as well as systems utilizing thermal initiators in combination with appropriate metal ions such as iron or copper.

Suitable azo compounds include, but are not limited to, non-water-soluble azo compounds, such as 1-1′-azobiscyclohexanecarbonitrile, 2-2′-azobisisobutyronitrile, 2-2′-azobis(2-methylbutyronitrile), 2-2′-azobis(propionitrile), 2-2′-azobis(2,4-dimethylvaleronitrile), 2-2′-azobis(valeronitrile), 2-(carbamoylazo)-isobutyronitrile and mixtures thereof, and water-soluble azo compounds, such as azobis tertiary alkyl compounds, which include, but are not limited to, 4-4′-azobis(4-cyanovaleric acid), 2-2′-azobis(2-methylpropionamidine)dihydrochloride, 2,2′-azobis[2-methyl-N-(2-hydroxyethyl)propionamide], 4,4′-azobis(4-cyanopentanoic acid), 2,2′-azobis(N,N′-dimethyleneisobutyramidine), 2,2′-azobis(2-amidinopropane) dihydrochloride, 2,2′-azobis(N,N′-dimethyleneisobutyramidine)dihydrochloride and mixtures thereof.

Suitable peroxides include, but are not limited to, hydrogen peroxide, methyl ethyl ketone peroxides, benzoyl peroxides, di-t-butyl peroxides, di-t-amyl peroxides, dicumyl peroxides, diacyl peroxides, decanoyl peroxide, lauroyl peroxide, peroxydicarbonates, peroxyesters, dialkyl peroxides, hydroperoxides, peroxyketals and mixtures thereof.

The average particle size of the second polymeric microparticles may be at least 200 Angstroms, or at least 800 Angstroms, or at least 1000 Angstroms, or at least 1500 Angstroms. The average particle size of the polymeric microparticles can be no more than 10,000 Angstroms, or not more than 8000 Angstroms, or not more than 5000 Angstroms, or not more than 2500 Angstroms. When the average particle size is too large, the microparticles may tend to settle from the latex emulsion upon storage. The average particle size of the polymeric microparticles may be any value or in any range of values-inclusive of those stated above.

The average particle size can be measured by photon correlation spectroscopy as described in International Standard ISO 13321. The average particle size values reported herein are measured by photon correlation spectroscopy using a Malvern Zetasizer 3000HSa according to the following procedure. Approximately 10 mL of ultrafiltered deionized water and 1 drop of a homogenous test sample are added to a clean 20 mL vial and then mixed. A cuvet is cleaned and approximately half-filled with ultrafiltered deionized water, to which about 3-6 drops of the diluted sample is added. Once any air bubbles are removed, the cuvet is placed in the Zetasizer 3000HSa to determine if the sample is of the correct concentration using the Correlator Control window in the Zetasizer Software (100 to 400 KCts/sec). Particle size measurements are then made with the Zetasizer 3000HSa.

The aqueous dispersion of second polymeric microparticles can, for example, be present in the film-forming composition in an amount of at least 1 percent by weight, or at least 2 percent by weight, or at least 5 percent by weight, based on total weight of resin solids present in the film-forming composition. Also, the aqueous dispersion of second polymeric microparticles can be present in the film-forming composition in an amount of not more than 20 percent by weight, or not more than 15 percent by weight, or not more than 10 percent by weight based on total weight of resin solids present in the film-forming composition. The amount of the aqueous dispersion of second polymeric microparticles present in the film-forming composition can range between any combination of these values inclusive of the recited values.

The substantially organic solvent-free film-forming compositions of the present invention can be thermoplastic film-forming compositions, or, alternatively, thermosetting compositions. As used herein, by “thermosetting composition” is meant one that “sets” irreversibly upon curing or crosslinking, wherein the polymer chains of the polymeric components are joined together by covalent bonds. This property is usually associated with a cross-linking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. Once cured or crosslinked, a thermosetting composition will not melt upon the application of heat and is insoluble in solvents. By contrast, a “thermoplastic composition” comprises polymeric components that are not joined by covalent bonds and thereby can undergo liquid flow upon heating and are soluble in solvents. See Saunders, K. J., Organic Polymer Chemistry, pp. 4142, Chapman and Hall, London (1973).

The film-forming compositions can contain, in addition to the components described above, a variety of other adjuvant materials. If desired, other resinous materials can be utilized in conjunction with the aforementioned dispersions of polymeric microparticles so long as the resultant coating composition is not detrimentally affected in terms of application, physical performance and appearance properties.

The film-forming compositions of the present invention can further include inorganic and/or inorganic-organic particles, for example, silica, alumina, including treated alumina (e.g. silica-treated alumina known as alpha aluminum oxide), silicon carbide, diamond dust, cubic boron nitride, and boron carbide.

In certain embodiments, the present invention is directed to film-forming compositions as previously described wherein the composition comprises a plurality of inorganic particles. Such inorganic particles may, for example, be substantially colorless, such as silica, for example, colloidal silica. Such materials may provide enhanced mar and scratch resistance. Other suitable inorganic microparticles include fused silica, amorphous silica, alumina, colloidal alumina, titanium dioxide, zirconia, colloidal zirconia and mixtures thereof. Such particles can have an average particle size ranging from sub-micron size (e.g. nanosized particles) up to 10 microns depending upon the end use application of the composition and the desired effect.

In certain embodiments, the particles comprise inorganic particles that have an average particle size ranging from 1 to 10 microns, or from 1 to 5 microns prior to incorporation into the film-forming composition. In other embodiments, the inorganic particles comprise aluminum oxide having an average particle size ranging from 1 to 5 microns prior to incorporation into the film-forming composition. In other embodiments, the inorganic particles comprise aluminum oxide having an average particle size ranging from 1 to 5 microns prior to incorporation into the film-forming composition.

In certain embodiments, such inorganic particles can, for example, have an average particle size less than 50 microns prior to incorporation into the composition. In other embodiments, the present invention is directed to film-forming compositions as previously described wherein the inorganic particles have an average particle size ranging from 1 to less than 1000 nanometers prior to incorporation into the composition. In other embodiments, the present invention is directed to film-forming compositions as previously described wherein the inorganic particles have an average particle size ranging from 1 to 100 nanometers prior to incorporation into the composition. In other embodiments, the present invention is directed to film-forming compositions as previously described wherein the inorganic particles have an average particle size ranging from 5 to 50 nanometers prior to incorporation into the composition. In other embodiments, the present invention is directed to film-forming compositions as previously described wherein the inorganic particles have an average particle size ranging from 5 to 25 nanometers prior to incorporation into the composition. The particle size may range between any combination of these values inclusive of the recited values. These materials may constitute, in certain embodiments of the present invention, up to 30 percent by weight of the total weight of the film-forming compositions.

In certain embodiments of the present invention, the particles can be present in the composition in an amount ranging from 0.05 to 5.0 percent by weight, or from 0.1 to 1.0 weight percent; or from 0.1 to 0.5 weight percent based on total weight of the film-forming composition. The amount of particles present in the composition can range between any combination of these values inclusive of the recited values.

The film-forming compositions also may contain a catalyst to accelerate the cure reaction, for example, between the blocked polyisocyanate curing agent and the reactive hydroxyl groups of the polymeric microparticules comprising the dispersion. Examples of suitable catalysts include organotin compounds such as dibutyl tin dilaurate, dibutyl tin oxide and dibutyl tin diacetate. Catalysts suitable for promoting the cure reaction between an aminoplast curing agent and the reactive hydroxyl and/or carbamate functional groups of the thermosettable dispersion include acidic materials, for example, acid phosphates such as phenyl acid phosphate, and substituted or unsubstituted sulfonic acids such as dodecylbenzene sulfonic acid or paratoluene sulfonic acid. The catalyst often is present in an amount ranging from 0.1 to 5.0 percent by weight, or, in some cases, 0.5 to 1.5 percent by weight, based on the total weight of resin solids present in the film-forming composition.

Other additive ingredients, for example, plasticizers, surfactants, thixotropic agents, anti-gassing agents, flow controllers, anti-oxidants, UV light absorbers and similar additives conventional in the art can be included in the compositions of the present invention. These ingredients typically are present in an amount of up to about 40 percent by weight based on the total weight of resin solids.

In certain embodiments of the present invention, the film-forming composition forms a generally continuous film at ambient temperature (approximately 23-28° C. at 1 atm pressure). A “generally continuous film” is formed upon coalescence of the applied coating composition to form a uniform coating upon the surface to be coated. By “coalescence” is meant the tendency of individual particles or droplets of the coating composition, such as would result upon atomization of a liquid coating when spray applied, to flow together thereby forming a continuous film upon the substrate which is substantially free from voids or areas of very thin film thickness between the coating particles.

The film-forming compositions of the present invention also may, in certain embodiments, be formulated to include one or more pigments or fillers to provide color and/or optical effects, or opacity. Such pigmented film-forming compositions may be suitable for use in multi-component composite coatings as discussed below, for example, as a primer coating or as a pigmented base coating composition in a color-plus-clear system, or as a monocoat topcoat.

The solids content of the film-forming composition generally ranges from 20 to 75 percent by weight, or 30 to 65 percent by weight, or 40 to 55 percent by weight, based on the total weight of the film-forming composition.

As aforementioned, the present invention is also directed to multi-layer composite coatings. The multi-layer composite coating compositions of the present invention comprise a base-coat film-forming composition serving as a basecoat (often a pigmented color coat) and a film-forming composition applied over the basecoat serving as a topcoat (often a transparent or clear coat). At least one of the basecoat film-forming composition and the topcoat film-forming composition comprises the film-forming composition of the present invention. The film-forming composition of the basecoat can be any of the compositions useful in coatings applications, including any of the previously described film-forming compositions in accordance with the present invention. The film-forming composition of the basecoat comprises a resinous binder and, often, one or more pigments to act as the colorant. Particularly useful resinous binders are acrylic polymers, polyesters, including alkyds and polyurethanes such as any of those discussed in detail above.

The resinous binders for the basecoat can be organic solvent-based materials such as those described in U.S. Pat. No. 4,220,679, note column 2 line 24 continuing through column 4, line 40, which is incorporated herein by reference. Also, water-based coating compositions such as those described in U.S. Pat. No. 4,403,003, U.S. Pat. No. 4,147,679 and U.S. Pat. No. 5,071,904 (incorporated herein by reference) can be used as the binder in the basecoat composition.

The basecoat composition can contain pigments as colorants. Suitable metallic pigments include aluminum flake, copper or bronze flake and metal oxide coated mica. Besides the metallic pigments, the basecoat compositions can contain non-metallic color pigments conventionally used in surface coatings including inorganic pigments such as titanium dioxide, iron oxide, chromium oxide, lead chromate, and carbon black; and organic pigments such as, for example, phthalocyanine blue and phthalocyanine green.

Optional ingredients in the basecoat composition include those which are well known in the art of formulating surface coatings, such as surfactants, flow control agents, thixotropic agents, fillers, anti-gassing agents, organic co-solvents, catalysts, and other customary auxiliaries. Examples of these materials and suitable amounts are described in U.S. Pat. Nos. 4,220,679, 4,403,003, 4,147,769 and 5,071,904, which are incorporated herein by reference.

The basecoat compositions can be applied to the substrate by any conventional coating technique such as brushing, spraying, dipping or flowing, but they are most often applied by spraying. The usual spray techniques and equipment for air spraying, airless spray and electrostatic spraying in either manual or automatic methods can be used.

During application of the basecoat to the substrate, the film thickness of the basecoat formed on the substrate often ranges from 0.1 to 5 mils (2.54 to about 127 micrometers), or 0.1 to 2 mils (about 2.54 to about 50.8 micrometers).

After forming a film of the basecoat on the substrate, the basecoat can be cured or alternately given a drying step in which solvent is driven out of the basecoat film by heating or an air drying period before application of the clear coat. Suitable drying conditions will depend on the particular basecoat composition, and on the ambient humidity if the composition is water-borne, but often, a drying time of from 1 to 15 minutes at a temperature of 75° to 200° F. (21° to 93° C.) will be adequate.

The solids content of the base coating composition often generally ranges from 15 to 60 weight percent, or 20 to 50 weight percent.

The topcoat, which often is a transparent composition, is often applied to the basecoat by spray application, however, the topcoat can be applied by any conventional coating technique as described above. Any of the known spraying techniques can be used such as compressed air spraying, electrostatic spraying and either manual or automatic methods. As mentioned above, the topcoat can be applied to a cured or to a dried basecoat before the basecoat has been cured. In the latter instance, the two coatings are then heated to cure both coating layers simultaneously. Curing conditions can range from 265° to 350° F. (129° to 175° C.) for 20 to 30 minutes. The topcoat thickness (dry film thickness) typically is 1 to 6 mils (about 25.4 to about 152.4 micrometers).

During application of the topcoat to the base coated substrate, ambient relative humidity generally can range from about 30 to about 80 percent, preferably about 50 percent to 70 percent.

In certain embodiments, after the basecoat is applied (and cured, if desired), multiple layers of clear topcoats can be applied over the basecoat. This is generally referred to as a “clear-on-clear” application. For example, one or more layers of a conventional transparent coat can be applied over the basecoat and one or more layers of transparent coating of the present invention applied thereon. Alternatively, one or more layers of a transparent coating of the present invention can be applied over the basecoat as an intermediate topcoat, and one or more conventional transparent coatings applied thereover.

The multi-layer composite coating compositions of the present invention can be applied over virtually any substrate including wood, metals, glass, cloth, plastic, foam, including elastomeric substrates and the like. They are particularly useful in applications over metals and elastomeric substrates that are utilized in the manufacture of motor vehicles. The substantially organic solvent-free film-forming compositions of the present invention can provide multi-component composite coating systems that have appearance and performance properties commensurate with those provided by solvent-based counterparts with appreciably less volatile organic emissions during application.

Illustrating the invention are the following examples, which, however, are not to be considered as limiting the invention to their details. Unless otherwise indicated, all parts and percentages in the following examples, as well as throughout the specification, are by weight.

### EXAMPLES

The following Examples A and B describe the preparation of resinous binders for use in the preparation of compositions of the present invention. Example C describes the preparation of water-dilutable additive materials for use in compositions of the present invention. Example D describes the preparation of a functional polysiloxane additive for use in compositions of the present invention. Example E describes the preparation of aqueous dispersions of polymeric microparticles prepared by emulsion polymerization for use in the preparation of compositions of the present invention. Examples F and G describes the preparation of film-forming compositions of the present invention that include materials prepared in Examples A, C and D. Example H describes the preparation of film-forming compositions of the present invention that include materials prepared in Examples B, C, D, and E.

### Example A

### Resinous Binder A

A resinous binder was prepared as described below from the ingredients of Table 1. The amounts listed are the total parts by weight in grams and the amount within parenthesis are total parts by weight solids, in grams.

TABLE 1

| Ingredient | Amount | |
|---|---|---|
| Charge 1 | | |
| Acrylic¹ | 2316.2 | (1466.2) |
| TRIXENE DP9B/1504² | 299.2 | (209.5) |
| MIBK³ | 53.7 | (0) |
| Charge 2 | | |
| TINUVIN 400⁴ | 73.9 | (62.8) |
| TINUVIN 123⁵ | 20.9 | (20.9) |
| BYK-390⁶ | 20.9 | (10.5) |
| Polybutylacrylate⁷ | 10.5 | (6.3) |
| Dibutyltin Dilaurate | 4.8 | (4.8) |
| Dimethyl Ethanolamine | 26.3 | (0) |
| SURFYNOL 2502⁸ | 14.7 | (14.7) |
| Charge 3 | | |
| MIBK | 53.7 | (0) |
| Charge 4 | | |
| Dimethyl Ethanolamine | 6.6 | (0) |
| Deionized Water | 3022.0 | (0) |
| Charge 5 | | |
| Deionized Water | 100.0 | (0) |
| Charge 6 | | |
| FOAM KILL 649⁹ | 1.7 | (1.7) |

¹Acrylic resin (30.3% styrene, 19.9% hydroxyethyl methacrylate; 28.7% CARDURA E (glycidyl neodecanoate available from Shell Chemical Co.), 11.0% acrylic acid, and 10.15% 2-ethylhexyl acrylate)
²Blocked isocyanate available from Baxenden Chemical Ltd., Lancashire, England.
³Methyl isobutyl ketone
⁴Light stabilizer available from Ciba Specialty Chemicals, Basel, Switzerland
⁵Light stabilizer available from Ciba Specialty Chemicals, Basel, Switzerland
⁶Acrylate leveling additive available from BYK-Chemie USA Inc., Wallingford, Connecticut
⁷60% solids in styrene
⁸Surfactant available from Air Products and Chemicals, Inc., Allentown, Pennsylvania
⁹Defoamer available from Crucible Chemical

Charge 1 and then charge 2 were added to a flask at ambient conditions and mixed until homogeneous. The temperature was increased to 25° C. At that temperature, the mixture was added to a flask containing charge 4, by dripping the mixture into the flask over one hour. Charge 3 was then added to the flask and the contents were held for 30 minutes. The resulting pre-emulsion was passed once through a Microfluidizer® M11T (available from Microfluidics Corp., Newton, Mass.) at 11,500 psi with cooling water to maintain the pre-emulsion at approximately room temperature. Charge 5 was then passed through the Microfluidizer to rinse. Solvents were removed by vacuum distillation. The final composition contained about 46 weight % solids with Charge 6 being added as needed during vacuum distillation.

### Example B

### Resinous Binder B

A resinous binder was prepared as described below from the ingredients of Table 2. The amounts listed are the total parts by weight in grams and the amount within parenthesis are total parts by weight solids, in grams.

TABLE 2

| Ingredient | Amount | |
|---|---|---|
| Charge 1 | | |
| Acrylic¹⁰ | 2182.8 | (1382.4) |
| Crosslinker¹¹ | 145.7 | (126.8) |
| Flex Acrylic¹² | 330.0 | (250.8) |
| MIBK | 47.3 | (0) |
| Charge 2 | | |
| TINUVIN 400 | 54.7 | (46.5) |
| TINUVIN 123 | 18.6 | (18.6) |
| BYK-337¹³ | 0.4 | (0.1) |
| DiMethyl Ethanolamine | 36.7 | (0) |
| Dimethyl Ethanolamine | 5.4 | (0) |
| SURFYNOL 2502 | 13.8 | (13.8) |
| Charge 3 | | |
| MIBK | 47.3 | (0) |
| Charge 4 | | |
| Dimethyl Ethanolamine | 9.2 | (0) |
| Deionized Water | 3151.0 | (0) |
| Charge 5 | | |
| Deionized Water | 88.0 | (0) |
| Charge 6 | | |
| FOAM KILL 649⁹ | 1.5 | (1.5) |
| ¹⁰Acrylic resin (28.67% styrene, 19.9% hydroxyethyl methacrylate, 28.6% CARDURA E (glycidyl neodecanoate available from Shell Chemical Co.), 12.75% acrylic acid, and 10.15% 2-ethylhexyl acrylate) | | |
| ¹¹Blocked isocyanate (87% solids in MIBK) produced by charging 1930.0 parts by weight DESMODUR N3300 (a trimer of hexamethylene diisocyanate available from Bayer Corporation) to a reactor containing 1.75 parts by weight dibutyltin dilaurate and 436.8 parts by weight MIBK. 540.7 parts by weight of benzyl alcohol was then added over 90 minutes keeping the temperature | | |
| # below 80° C. After completion of this addition, the reaction temperature was maintained at 80° C. and monitored by infrared spectroscopy for disappearance of the isocyanate band. | | |

¹²Acrylic resin (31.4% CARDURA E (glycidyl neodecanoate available from Shell Chemical Co.), 5.5% isostearic acid, 12.2% methyl methacrylate, 10.3% styrene, 17.1% 2-ethylhexyl acrylate, 12.9% hydroxyethyl acrylate, 10.6% acrylic acid)
¹³Solution of a polyether modified poly-dimethyl-siloxane available from BYK-Chemie USA Inc., Wallingford, Connecticut

Charge 1 and then charge 2 were added to a flask at ambient conditions and mixed until homogeneous. The temperature was increased to 25° C. At that temperature, the mixture was added to a flask containing charge 4, by dripping the mixture into the flask over one hour. Charge 3 was then added to the flask and the contents were held for 30 minutes. The resulting pre-emulsion was passed once through a Microfluidizer® M110T (available from Microfluidics Corp., Newton, Mass.) at 11,500 psi with cooling water to maintain the pre-emulsion at approximately room temperature. Charge 5 was then passed through the Microfluidizer to rinse. Solvents were removed by vacuum distillation. The final composition contained about 46 weight % solids with Charge 6 being added as needed during vacuum distillation.

### Example C

### Water Dilutable Additive C

Table 3 sets forth the components and amounts for various water dilutable additives C1 through C12 that were prepared as described below.

TABLE 3

| Ex- | | | | |
|---|---|---|---|---|
| am- | | Isocyanate | | Polyethylene |
| ple | Isocyanate | Equiv- | Methoxypolyethyelene | Glycol |
| No. | Type | alents | Glycol Type | Equivalents |
| C1 | IPDI¹⁴ | 1.0 | MPEG 2000²⁰ | 1.004 |
| C2 | IPDI | 1.0 | MPEG 750²¹ | 1.004 |
| C3 | IPDI | 1.0 | MPEG 550²² | 1.004 |
| C4 | IPDI | 1.0 | MPEG 350²³ | 1.004 |
| C5 | TDI¹⁵ | 1.0 | MPEG 2000 | 1.004 |
| C6 | m-TMXDI¹⁶ | 1.0 | MPEG 2000 | 1.004 |
| C7 | HDI¹⁷ | 1.0 | MPEG 2000 | 1.004 |
| C8 | HDI | 1.0 | MPEG 2000 | 1.004 |
| | Trimer¹⁸ | | | |
| C9 | IPDI | 1.0 | MPEG 2000 | 1.004 |
| | Trimer¹⁹ | | | |
| C10 | IPDI | 1.0 | MPEG 2000/MPEG 750 | 0.502/0.502 |
| C11 | IPDI | 1.0 | MPEG 2000/MPEG 550 | 0.502/0.502 |
| C12 | IPDI | 1.0 | MPEG 2000/MPEG 350 | 0.502/0.502 |

¹⁴Isophorone Diisocyanate
¹⁵Toluene Diisocyanate
¹⁶META-Tetramethylxylylene Diisocyanate commercially available from CYTEC Industries, Inc.
¹⁷Hexamethylene Diisocyanate
¹⁸DEMODUR 3390 commercially available from Bayer Corporation
¹⁹T-1890L commercially available from DeGussa Corporation
²⁰CARBOWAX MPEG 2000 commercially available from The Dow Chemical Company
²¹CARBOWAX MPEG 750 commercially available from The Dow Chemical Company
²²CARBOWAX MPEG 550 commercially available from The Dow Chemical Company
²³CARBOWAX MPEG 350 commercially available from The Dow Chemical Company

In each case, the isocyanate, the polyethylene glycol, and methyl isobutyl ketone were charged to a glass reactor equipped with an agitator, condenser, thermocouple, and nitrogen blanket. The charge was heated to 55° C. After complete dissolution of the charge, a charge of dibutyl tin dilaurate was added (0.05% by weight based on the total weight of the reactants). The reactants were then slowly heated over a one-half hour period to about 90° C. If an exotherm occurred, the reactants were cooled to 85-90° C. The reaction was monitored by infrared spectroscopy for disappearance of the isocyanate peak. Deionized water was then added to the reactor over a 20 minute period to give a dispersion solids of about 64.5%. The dispersions were held for one hour at about 70-75° C. under agitation. The product was then distilled to remove methyl isobutyl ketone and provide a final dispersion solid of about 40-45%.

### Example D

### Water Dilutable Additive D

A reactive functional group-containing polysiloxane was prepared from a polysiloxane polyol that was prepared as described below from the mixture of ingredients of Table 4.

TABLE 4

| | Equivalent | | Parts By Weight |
|---|---|---|---|
| Ingredients | Weight² | Equivalents | (kilograms) |
| Charge I: | | | |
| Trimethylolpropane | 174.0 | 756.0 | 131.54 |
| monoallyl ether | | | |
| Charge II: | | | |
| MASILWAX BASE²⁴ | 156.7²⁵ | 594.8 | 93.21 |
| Charge III: | | | |
| Chloroplatinic acid | | 10 ppm | |
| Toluene | | | 0.23 |
| Isopropanol | | | 0.07 |

²⁴Polysiloxane-containing silicon hydride, commercially available from Lubrizol Corporation.
²⁵Equivalent weight based on mercuric bichloride determination.

To a suitable reaction vessel equipped with a means for maintaining a nitrogen blanket, Charge I and an amount of sodium bicarbonate equivalent to 20 to 25 ppm of total monomer solids was added at ambient conditions and the temperature was gradually increased to 75° C. under a nitrogen blanket. At that temperature, about 5.0% of Charge II was added under agitation, followed by the addition of Charge III, equivalent to 10 ppm of active platinum based on total monomer solids. The reaction was then allowed to exotherm to 95° C. at which time the remainder of Charge II was added at a rate such that the temperature did not exceed 95° C. After completion of this addition, the reaction temperature was maintained at 95° C. and monitored by infrared spectroscopy for disappearance of the silicon hydride absorption band (Si—H, 2150 cm⁻¹).

To produce the reactive functional group-containing polysiloxane, 360.3 grams of the polysiloxane polyol described above was added to a reaction flask. The polyol was then heated to 60° C. and 84.4 g of m-hexahydrophthalic anhydride was added over 30 minutes. The reaction was held 3 hours and checked for complete reaction by IR (disappearance of peak at 1790). The reaction was then cooled to ambient temperature and 44.7 g of dimethyl ethanolamine was added over 30 minutes. The reaction was held at ambient temperature for 15 minutes and 383.6 g of deionized water added over 3 hours.

### Example E

Additive E—Aqueous Dispersions of Polymeric Microparticles

The aqueous dispersions of Polymeric microparticles of Examples E1 to E9 prepared by emulsion polymerization were prepared as described below from a mixture of the following ingredients in a glass reactor equipped with an agitator, a nitrogen blanket, a monomer feed zone, and a thermocouple.

CHARGE 1

| | |
|---|---|
| Deionized Water | 0.15% active weight percent based on monomer |
| AEROSOL OT75²⁶ | charge |
| Sodium Bicarbonate | 0.125% by weight based on monomer charge |

²⁶A 75% solution of dioctylsodium sulfosuccinate in isoproponal available from CYTEC Industries, Inc.

CHARGE 2

| | |
|---|---|
| Ammonium Persulfate | 0.4% by weight based on monomer charge |
| Water | |

### Charge 3

Pre-emulsions (weight ratio of monomer to water of 55:45) were prepared from the monomers listed in Table 5 (weight percent based on 100 parts monomer) using 0.5% Aerosol OT75 by active weight based on the monomer charge. The pre-emulsions were prepared by mixing the monomers with the water and surfactant for 30 minutes.

TABLE 5

| Example | Monomer | | | | | | | | |
|---|---|---|---|---|---|---|---|---|---|
| No. | Styrene | MMA²⁷ | BA²⁸ | AA²⁹ | NMA³⁰ | HEMA³¹ | PS³² | pH | % Gel³³ |
| E1 | 44.75 | 44 | 0 | 8.5 | 2 | 2.5 | 1480 | 8.8 | 88 |
| E2 | 89.5 | 0 | 0 | 8.5 | 2 | 0 | 1500 | 7.83 | 98 |
| E3 | 45 | 44.5 | 0 | 8.5 | 2 | 0 | 1500 | 8.85 | 88 |
| E4 | 22.38 | 67.12 | 0 | 8.5 | 2 | 0 | 1350 | 8.62 | 71 |
| E5 | 53.25 | 44.75 | 0 | 2 | 0 | 0 | 1300 | 9.03 | 2 |
| E6 | 44.75 | 42.25 | 0 | 8.5 | 2 | 2.5 | 940⁸ | 8.7 | — |
| E7 | 44.75 | 0 | 42.25 | 8.5 | 2 | 0 | 1800 | 7.15 | 98 |
| E8 | 53.25 | 0 | 44.75 | 2 | 2 | 0 | 1800 | 9.75 | — |
| E9 | 90.75 | 0 | 0 | 8.5 | 1.25 | 0 | 1600 | 8.6 | 96 |

²⁷Methyl Methacrylate.
²⁸Butyl Methacrylate.
²⁹Acrylic Acid.
³⁰A 50% solution of N-Methylolacrylamide in water available from Cytec Industries, Inc.
³¹Hydroxy Ethyl Methacrylate.
³²Average particle size measured by photon correlation spectroscopy using a Malvern Zetasizer 3000Hsa.
³³As measured by digestion of dry particles in acetone.
³⁴The amount of surfactant was tripled to reduce particle size.

Charge 1 was heated to about 80° C. under a blanket of nitrogen. Charge 2 was added at this temperature and held for five minutes. Charge 3 was added over a three-hour period followed by a one-hour hold. The reaction was allowed to cool to about less than 50° C. and a portion of dimethyl amino ethanol in water (50:50 ratio) was added to increase the pH to at least 7.0. The final solids of the polymers was about 32%.

### Example F1

### Film-Forming Compositions Containing Materials From Examples A, C and D

Film-forming compositions were prepared as described below from the components listed in Table 6. Seven film-forming compositions were prepared for Example F1 by varying the Example C additive as reflected in Table 7.

TABLE 6

| Component | | Amount |
|---|---|---|
| No. | Description | (grams) |
| 1 | Resinous Binder of Example A | 183.5 |
| 2 | Polysiloxane of Example D | 2.13 |
| 3 | TEXANOL³⁵ | 9.0 |
| 4 | Butyl Acetate³⁶ | 3.0 |
| 5 | Deionized water | 29.00 |
| 6 | Additives of Example C | 12.5 |
| 7 | CYMEL 327³⁷ | 12.8 |
| 8 | CYMEL 303³⁸ | 3.0 |
| 9 | Premix 1 | |
| | CYMEL 327 | 5.3 |
| | AEROSIL 200³⁹ | 0.2 |
| 10 | Premix 2 | |
| | Dodecylbenzylsulfonic Acid | 0.2 |
| | Dimethylethanolamine (50% in deionized | 0.182 |
| | water)⁴⁰ | |
| | Deionized water | 0.160 |
| 11 | Premix 3 | |
| | BORCHI Gel LW44⁴¹ | 0.24 |
| | Deionized Water | 0.96 |

³⁵2,2,4 Trimmethyl-1,3 Pentanediol Monoisobuterate available from Dow Chemical Company
³⁶N-Butyl Acetate available from Dow Chemical Company
³⁷High Imino Melamine-Formaldehyde Crosslinking Agent available from Cytec Industries, Inc.
³⁸Hexamethoxymethyl melamine resin available from Cytec Industries, Inc.
³⁹Silica commercially available from Degussa Corporation.
⁴⁰Available from PPG Industries, Inc.
⁴¹Non-ionic, polyurethane based thickener available from Borchers GmbH

Premix 1 was prepared by adding the Areosil 200 to the Cymel 327 and stirring. The mixture was added to an EIGER mill to achieve a grind fineness of 7+Hegman. Premix 2 was prepared slowly agitating dodecylbenzylsulfonic acid and adding demethylehtanolamine (50% in deionized water) and deionized water. Premix 3 was prepared by stirring the Borchi Gel LW44 and adding deionized water until a uniform consistency was achieved.

The film-forming composition was prepared by charging component 1 and then adding component 2 under agitation until fully incorporated. Then, under moderate agitation, components 3 to 11 were added. The final compositions had a solids content of 45% and a viscosity of 30 seconds using a #4 Din cup.

### Test Substrates

The test substrates were ACT cold-roll steel panels (4″×12″) supplied by ACT Laboratories, Inc. and were electrocoated with a cationic electrodepositable primer commercially available from PPG Industries, Inc. as ED-6060. The panels were then spray coated in two coats with EWB Reflex Silver Basecoat commercially available from PPG Industries, Inc. to film thicknesses ranging from 0.4 to 0.6 mils. The basecoat was flashed for 5 minutes at ambient temperature and then baked for 5 minutes at 176° F. (80° C.). The substrate was then cooled to ambient temperature. After cooling, film-forming compositions of Example F1 were spray applied, with a target film thickness of 1.3 to 1.7 mils, in two coats without flash time between coats. The substrates coated with the Example F1 compositions were flashed for 2 minutes at ambient temperature and then the coated substrates were placed in an oven at 150° C., prior to increasing the oven temperature to 311° C. The coated substrates were cured for 23 minutes in an oven set at 311° C. Appearance and properties for the coatings are reported below in Table 7.

TABLE 7

| | Water Dilutable | | | | | | |
|---|---|---|---|---|---|---|---|
| Coating | Additive C | | | | | | % 20° Gloss Retained |
| Example No. | Example No. | Gloss⁴² | Haze⁴² | DOI⁴³ | LW⁴⁴ | SW⁴⁴ | after scratch testing⁴⁵ |
| F1a | C1 | 100 | 345 | 76 | 4 | 14 | 56 |
| F1b | C4 | 99 | 331 | 78 | 4 | 15 | 40 |
| F1c | C10 | 99 | 322 | 81 | 3 | 15 | 41 |
| F1d | C12 | 99 | 350 | 75 | 8 | 14 | 46 |
| F1e | C3 | 99 | 339 | 81 | 4 | 17 | 44 |
| F1f | C11 | 100 | 350 | 77 | 4 | 13 | 46 |
| F1g | C2 | 99 | 330 | 83 | 3 | 15 | 43 |
| ⁴²Gloss and haze of test panels coated as described above was determined at a 20° angle using a Micro-TriGloss Reflectometer available from BYK Gardner, Inc. | | | | | | | |
| ⁴³Distinctness of image (“DOI”) of sample panels was determined using a Dorigon II DOI Meter, which is commercially available from Hunter Lab, where a higher value indicates better coating appearance on the test panel. | | | | | | | |
| ⁴⁴Smoothness of the coated test panels was measured using a Byk Wavescan in which results are reported as long wave and short wave numbers where lower values mean smoother films. | | | | | | | |
| ⁴⁵Coated panels were subjected to scratch testing by linearly scratching the coated surface with a weighted abrasive paper for ten double rubs using an Atlas AATCC Scratch Tester, Model CM-5, available from Atlas Electrical Devices Company of Chicago, Illinois. The abrasive paper used was 3M 281Q WETORDRY ™ PRODUCTION ™ 9 micron polishing paper sheets, which are commercially available from 3M Company of St. Paul, Minnesota. | | | | | | | |
| # Panels were then rinsed with tap water and carefully patted dry with a paper towel. The 20° gloss was measured (using the same gloss meter as that used for the initial 20° gloss) on the scratched area of each test panel. Using the lowest 20° gloss reading from the scratched area, the scratch results are reported as the percent of the initial gloss retained after scratch testing using the following calculation: 100% * (scratched)/(initial gloss). | | | | | | | |
| # Higher values for percent of gloss retained are desirable. | | | | | | | |

### Example F2

### Film-Forming Compositions Containing Materials From Examples A, C and D

Film-forming compositions were prepared as described below from the components listed in Table 8. The compositions were prepared in the same manner as the compositions of Example F1 described above. Seven film-forming compositions were prepared for Example F2 by varying the Example C additive as reflected in Table 9.

TABLE 8

| Component | | Amount |
|---|---|---|
| No. | Description | (grams) |
| 1 | Resinous Binder of Example A | 183.5 |
| 2 | Polysiloxane of Example D | 2.13 |
| 3 | TEXANOL | 9.0 |
| 4 | Butyl Acetate | 3.0 |
| 5 | Deionized water | 29.00 |
| 6 | Additives of Example C | 7.7 |
| 7 | CYMEL 327 | 12.8 |
| 8 | CYMEL 303 | 3.0 |
| 9 | Premix 1 | |
| | CYMEL 327 | 5.3 |
| | AEROSIL 200 | 0.2 |
| 10 | Premix 2 | |
| | Dodecylbenzylsulfonic Acid | 0.2 |
| | Dimethylethanolamine (50% in deionized | 0.182 |
| | water) | |
| | Deionized water | 0.160 |
| 11 | Premix 3 | |
| | BORCHI Gel LW44 | 0.24 |
| | Deionized Water | 0.96 |

### Test Substrates

The test substrates were prepared in the same manner as is described in Example F1 above. Appearance and properties for the coatings of Example 2 are reported below in Table 9. These properties were measured by the same methods as described above for the coatings of Example F1.

TABLE 9

| Coating | Water | | | | | | % 20° Gloss |
|---|---|---|---|---|---|---|---|
| Ex- | Dilutable | | | | | | Retained |
| ample | Additive C | | | | | | after scratch |
| No. | Example No. | Gloss | Haze | DOI | LW | SW | testing |
| F2a | C1 | 100 | 337 | 80 | 3 | 17 | 56 |
| F2b | C4 | 96 | 335 | 71 | 6 | 16 | 48 |
| F2c | C10 | 99 | 347 | 74 | 5 | 15 | 50 |
| F2d | C12 | 99 | 343 | 72 | 5 | 15 | 49 |
| F2e | C3 | 99 | 340 | 78 | 4 | 15 | 39 |
| F2f | C11 | 99 | 341 | 75 | 4 | 15 | 54 |
| F2g | C2 | 99 | 344 | 73 | 5 | 15 | 43 |

### Example G

### Compositions Containing Materials From Examples A, C1 and D

Film-forming compositions were prepared as described below from the components listed in Table 10.

TABLE 10

| | | Amount (grams) | | | |
|---|---|---|---|---|---|
| Component | | Example | Example | Example | Example |
| No. | Description | G1 | G2 | G3 | G4 |
| 1 | Resinous Binder of Example A | 174.6 | 174.6 | 174.6 | 174.6 |
| 2 | Byk 345⁴⁶ | 0.48 | 0.48 | 0.48 | 0.48 |
| 3 | Byk 325⁴⁷ | 0.24 | 0.24 | 0.24 | 0.24 |
| 4 | Polysiloxane of Example D | 4.25 | 4.25 | 4.25 | 4.25 |
| 5 | TEXANOL | 10.0 | 10.0 | 10.0 | 10.0 |
| 6 | Isobutanol | 6.0 | 6.0 | 6.0 | 6.0 |
| 7 | Isostearyl Alcohol | 4.0 | 4.0 | 4.0 | 4.0 |
| 8 | Deionized water | 15.0 | 15.0 | 15.0 | 15.0 |
| 9a | Additive of Example C1 | 0 | 2.5 | 6.3 | 10.5 |
| 9b | CYMEL 303 | 3.1 | 0 | 0 | 0 |
| 10 | Premix 1 | | | | |
| | CYMEL 327 | 19.88 | 23.5 | 23.5 | 23.5 |
| | AEROSIL 200 | 0.4 | 0.4 | 0.4 | 0.4 |
| 11 | Premix 2 | | | | |
| | Dodecylbenzylsulfonic Acid | 0.196 | 0.196 | 0.196 | 0.196 |
| | Dimethylethanolamine (50% in | 0.167 | 0.167 | 0.167 | 0.167 |
| | deionized water) | | | | |
| | Deionized water | 0.167 | 0.167 | 0.167 | 0.167 |
| 12 | Premix 3 | | | | |
| | BORCHI Gel LW44 | 0.214 | 0.4 | 0.4 | 0.374 |
| | Deionized Water | 0.856 | 1.6 | 1.6 | 1.496 |

⁴⁶Available from Byk-Chemie, Wallingford, CT.
⁴⁷Available from Byk-Chemie, Wallingford, CT.

Premix 1 was prepared by adding the Areosil 200 to the Cymel 327 and string. The mixture was added to an EIGER mill to achieve a grind fineness of 7+Hegman. Premix 2 was prepared slowly agitating dodecylbenzylsulfonic acid and adding demethylehtanolamine (50% in deionized water) and deionized water. Premix 3 was prepared by stirring the Borchi Gel LW44 and adding deionized water until a uniform consistency was achieved.

The film-forming composition was prepared by charging components 1 through 3 and then adding component 4 under agitation until fully incorporated. Then, under moderate agitation, components 5 to 12 were added. The final compositions had a solids content of 45% and a viscosity of about 30 seconds using a #4 Din cup.

### Test Substrates

The test substrates were ACT cold roll steel panels (4″×12″) supplied by ACT Laboratories, Inc. and were electrocoated with a cationic electrodepositable primer commercially available from PPG Industries, Inc. as ED-6060. The panels were then spray coated in two coats with EWB Obsidian Schwartz Basecoat commercially available from PPG Industries, Inc. to film thicknesses ranging from 0.4 to 0.6 mils. The basecoat was flashed for 5 minutes at ambient temperature and then baked for 5 minutes at 176° F. (80° C.). The substrate was then cooled to ambient temperature. After cooling, film-forming compositions of Example G1-G4 were spray applied, with a target film thickness of 1.3 to 1.7 mils, in two coats without flash time between coats. The substrates coated with the Example G compositions were flashed for 2 minutes at ambient temperature and then the substrates were placed in an oven at 150° C., prior to increasing the oven temperature to 311° C. The coated substrates were cured for 23 minutes in an oven set at 311° C. Appearance and properties for the coatings of Example G are reported below in Table 11.

TABLE 11

| | | | | | | % 20° Gloss | Pop |
|---|---|---|---|---|---|---|---|
| Coating | | | | | | Retained | Resistance |
| Example | | | | | | after scratch | microns |
| No. | Gloss | Haze | DOI | LW | SW | testing | pop⁴⁸ |
| G1 | 93 | 17 | 87 | 7.4 | 15.8 | 24 | 35 |
| G2 | 93 | 21 | 92 | 9.7 | 18.5 | 24 | 40 |
| G3 | 93 | 90 | 20 | 9.1 | 16.7 | 31 | 42 |
| G4 | 92 | 24 | 92 | 7.2 | 17.2 | 24 | 45 |
| ⁴⁸Pop resistance (measures the ability of the coating to resist the release of air from the coating composition as it is cured) was evaluated visually by examining the panels for pops and noting the film thickness at which the popping begins. This is done by visually viewing the panel and determining the lowest film build without significant popping for panels coated with increasing film thickness along the distance from the top of the panel which had the | | | | | | | |
| # lowest film build. A higher value indicates better resistance to popping. | | | | | | | |

### Example H

### Compositions Containing Materials From Examples B, C, D and E

Film-forming compositions were prepared as described below from the components listed in Table 12.

TABLE 12

| Component | | Amount |
|---|---|---|
| No. | Description | (grams) |
| 1 | Resinous Binder of Example B | 142.25 |
| 2 | Microparticles of Example E | 4.75 |
| 3 | Polysiloxane from Example D | 2.13 |
| 4 | TEXANOL | 10.0 |
| 5 | Isosteryl Alcohol⁴⁶ | 4.0 |
| 6 | Deionized water | 29.00 |
| 7 | Additive from Example C1 | 12.5 |
| 8 | CYMEL 303 | 3.0 |
| 9 | Premix 1 | |
| | RESIMENE 741⁴⁷ | 12.0 |
| | AEROSIL 200 | 0.24 |
| 10 | Premix 2 | |
| | Dodecylbenzylsulfonic Acid | 0.2 |
| | Dimethylethanolamine (50% in deionized | 0.182 |
| | water) | |
| | Deionized water | 0.160 |
| 11 | Premix 3 | |
| | BORCHI Gel LW44 | 0.24 |
| | Deionized Water | 0.96 |

⁴⁶Available from Goldschmidt Chemcial Corp., Hopewell, Virginia.
⁴⁷Aminoplast resin available examethoxymethyl melamine resin available from Cytec Industries, Inc.

Premix 1 was prepared by adding the AEROSIL 200 to the RESIMENE 741 and stirring. The mixture was added to an EIGER mill to achieve a grind fineness of 7+Hegman. Premix 2 was prepared slowly agitating dodecylbenzylsulfonic acid and adding demethylehtanolamine (50% in deionized water) and deionized water. Premix 3 was prepared by stirring the Borchi Gel LW44 and adding deionized water until a uniform consistency is achieved.

The film-forming composition was prepared by blending components 1 and 2 and then adding component 3 under agitation until fully incorporated. Then, under moderate agitation, components 3 to 11 are added. The final compositions had a solids content of 45% and a viscosity of 30 seconds using a #4 Din cup.

### Test-Substrates

The test substrates were prepared in the same manner as is described in Example F1. Appearance and properties for the coatings of Example G are reported below in Table 13. The gloss, haze, DOI, and LW/SW smoothness were measured by the same methods as described for the coatings of Example F1.

TABLE 13

| | Addi- | | | | | | Pop re- | |
|---|---|---|---|---|---|---|---|---|
| Coating | tive E | | | | | | sistance | Pop for |
| Exam- | Exam- | | | | | | microns | control |
| ple No. | ple No. | Gloss | Haze | DOI | LW | SW | pop⁴⁸ | each set |
| Control | None | 95 | 17 | 96 | 4.8 | 19.2 | 40 | |
| G1 | E1 | 94 | 14 | 97 | 1.6 | 7.0 | 50 | 45 |
| G2 | E2 | 94 | 17 | 94 | 6.3 | 12.2 | 100 | 40 |
| G3 | E3 | 96 | 16 | 90 | 19.3 | 17.9 | 45 | 40 |
| G4 | E4 | 96 | 17 | 89 | 17.7 | 20.3 | 48 | 40 |
| G5 | E5 | 94 | 14 | 97 | 1.6 | 8 | 45 | 45 |
| G6 | E6 | 95 | 15 | 95 | 6.2 | 17.5 | 38 | 41 (with |
| | | | | | | | | control |
| | | | | | | | | MG 45) |
| G7 | E9 | 95 | 15 | 96 | 4 | 22.8 | 47 | 45 |

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the embodiments described in detail herein are illustrative only and are not limiting to the scope of the invention which is to be given the full breadth of the appended claims and any and all equivalents thereof.

1. A film-forming composition that is substantially free of organic solvent, comprising:
a resinous binder; and
at least one first water dilutable additive comprising the reaction product of
(i) a reactant comprising at least one isocyanate functional group with (ii) an active hydrogen containing alkoxypolyalkylene compound.

2. The film-forming composition of claim 1 wherein the reactant (i) comprises a polyisocyanate selected from the group consisting of aliphatic polyisocyanates, cycloaliphatic polyisocyanates, aromatic polyisocyanates, and mixtures thereof.

3. The film-forming composition of claim 2, wherein the reactant (i) comprises a diisocyanate.

4. The film-forming composition of claim 3, wherein the diisocyanate is isophorone diisocyanate.

5. The film-forming composition of claim 1, wherein the reactant (ii) comprises an alkoxyethylene glycol.

6. The film-forming composition of claim 5, wherein the reactant (ii) comprises a methoxypolyethylene glycol.

7. The film-forming composition of claim 1, wherein the first water dilutable additive is present in the film-forming composition in an amount ranging from about 0.01 to about 10 percent by weight based upon the total weight of resin solids present in the film-forming composition.

8. The film-forming composition of claim 1, further comprising at least one second water dilutable additive which is different from the at least one first water dilutable additive, wherein the second water dilutable additive comprises a reactive functional group-containing polysiloxane.

9. The film-forming composition of claim 8 wherein the second water dilutable additive comprising a reactive functional group-containing polysiloxane comprises a carboxylic acid functional group-containing polysiloxane.

10. The film-forming composition of claim 9 wherein the carboxylic acid functional group-containing polysiloxane has the following general structural formula: 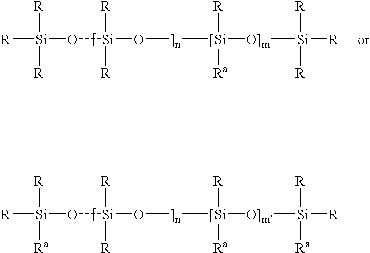
where m is at least 1; m′ is 0 to 50; n is 0 to 50; R is selected from the group consisting of OH and monovalent hydrocarbon groups connected to the silicon atoms; Ra has the following structure:
R₁—O—X
wherein R₁ is alkylene, oxyalkylene or alkylene aryl; and X contains COOH functional groups.

11. The film-forming composition of claim 10 wherein the carboxylic acid functional group-containing polysiloxane is the reaction product of the following:
(A) a polysiloxane polyol of the following general formula: 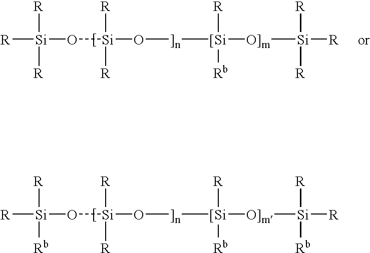
where m is at least 1; m′ is 0 to 50; n is 0 to 50; R is selected from the group consisting of H, OH and monovalent hydrocarbon groups connected to the silicon atoms; Rb has the following structure:
R₁—O—Y
wherein R₁ is alkylene, oxyalkylene or alkylene aryl; and the moiety Y is H, mono-hydroxy-substituted alkyl or oxyalkyl, or has the structure of CH₂C(R₂)ₐ(R₃)_{b} wherein R₂ is CH₂OH, R₃ is an alkyl group containing from 1 to 4 carbon atoms, a is 2 or 3, and b is 0 or 1; and (B) at least one polycarboxylic acid or anhydride.

12. The film-forming composition of claim 11 wherein reactant (B) comprises an anhydride.

13. The film-forming composition of claim 12 wherein reactant (B) is selected from the group consisting of hexahydrophthalic anhydride, methyl hexahydrophthalic anhydride, phthalic anhydride, trimellitic anhydride, succinic anhydride, alkenyl succinic anhydride and substituted alkenyl succinic anhydride, and mixtures thereof.

14. The film-forming composition of claim 8 wherein the second water dilutable additive comprising a reactive functional group-containing polysiloxane is present in the film forming composition in an amount ranging from 0.1 to 10.0 percent by weight based on the weight of total solids present in the film-forming composition.

15. The film-forming composition of claim 14 wherein the second water dilutable additive comprising a reactive functional group-containing polysiloxane is present in the film forming composition in an amount ranging from 0.1 to 5.0 percent by weight based on the weight of total solids present in the film-forming composition.

16. The film-forming composition of claim 15 wherein the second water dilutable additive comprising a reactive functional group-containing polysiloxane is present in the film forming composition in an amount ranging from 0.1 to 1.0 percent by weight based on the weight of total solids present in the film-forming composition.

17. The film-forming composition of claim 1, wherein the resinous binder comprises (1) at least one reactive functional group-containing polymer and (2) at least one crosslinking agent having functional groups reactive with the functional groups of the polymer.

18. The film-forming composition of claim 17, wherein the polymer (1) is selected from the group consisting of acrylic polymers, polyester polymers, polyurethane polymers, polyether polymers, polysiloxane polymers, polyepoxide polymers, copolymers thereof, and mixtures thereof.

19. The film-forming composition of claim 17, wherein the polymer (1) contains functional groups selected from the group consisting of hydroxyl groups, carbamate groups, carboxyl groups, isocyanate groups, amino groups, amido groups, and combinations thereof.

20. The film forming composition of claim 1, wherein the resinous binder comprises an aqueous dispersion comprising polymeric microparticles that are adapted to react with a crosslinking agent.

21. The film-forming composition of claim 20, wherein the polymeric microparticles are prepared from at least one polymer having reactive functional groups and at least one crosslinking agent.

22. The film forming composition of claim 21, wherein the polymer comprises a substantially hydrophobic polymer.

23. The film-forming composition of claim 1, wherein the resinous binder comprises an aqueous dispersion of polymeric microparticles prepared from (1) one or more reaction products of ethylenically unsaturated monomers, at least one of which contains at least one acid functional group, (2) one or more polymers different from (1) and (3), and (3) one or more crosslinking agents having functional groups reactive with those of at least one of the reaction product (1) and the polymer (2).

24. The film-forming composition of claim 23, wherein the polymer (2) comprises a substantially hydrophobic polymer and the crosslinking agent (3) comprises a substantially hydrophobic crosslinking agent.

25. The film-forming composition of claim 1, wherein the resinous binder comprises an aqueous dispersion of polymeric microparticles prepared from (A) at least one functional group-containing reaction product of polymerizable, ethylenically unsaturated monomers; and (B) at least one reactive organopolysiloxane.

26. The film forming composition of claim 25, wherein the polymeric microparticles are also prepared from (C) at least one substantially hydrophobic crosslinking agent.

27. The film-forming composition of claim 26, wherein (B) comprises at least one of the following structural unit:
R¹ₙR²ₘ—(—Si—O)_{(4-n-m)/2}
wherein m and n each represent a positive number fulfilling the requirements of: 0<n<4; 0<m<4; and 2≦m+n)<4; R¹ represents H, OH or monovalent hydrocarbon groups; and R² represents a monovalent reactive functional group-containing organic moiety.

28. The film-forming composition of claim 25, wherein the reactive organopolysiloxane is substantially hydrophobic.

29. The film-forming composition of claim 1, further comprising at least one crosslinking agent that is adapted to be at least one of water soluble and water dispersible.

30. The film-forming composition of claim 29, wherein the crosslinking agent that is adapted to be at least one of water soluble and water dispersible is selected from the group consisting of polyisocyanates, aminoplast resins, and mixtures thereof.

31. The film-forming compositions of claim 29, wherein the crosslinking agent that is adapted to be at least one of water soluble and water dispersible is present in the film-forming composition in an amount ranging from 0 to 70 percent by weight based on total weight of resin solids present in the composition.

32. The film-forming composition of claim 1, further comprising an aqueous dispersion of polymeric microparticles prepared by emulsion polymerization of a monomeric composition comprising (1) at least 10 percent by weight of one or more vinyl aromatic compounds; (2) 0.1 to 10 percent by weight of one or more carboxylic acid functional polymerizable, ethylenically unsaturated monomers; (3) 0 to 10 percent by weight of one or more polymerizable monomers having one or more functional groups which are capable of reacting to form crosslinks; and (4) one or more polymerizable ethylenically unsaturated monomers, where the weight percentages are based on total weight of monomers present in the monomeric composition, and
wherein each of (1), (2), (3) and (4) above is different one from the other, and at least one of (3) and (4) is present in the monomeric composition.

33. The film-forming composition of claim 1, further comprising inorganic particles selected from fumed silica, amorphous silica, colloidal silica, alumina, colloidal alumina, titanium dioxide, zirconia, colloidal zirconia and mixtures thereof.

34. The film-forming composition of claim 33, wherein the inorganic particles have an average particle size ranging from 1 to 1000 nanometers prior to incorporation into the composition.

35. The film-forming composition of claim 33, wherein the inorganic particles have an average particle size ranging from 1 to 10 microns prior to incorporation into the composition.

36. The film-forming composition of claim 1, further comprising at least one pigment.

37. A substrate having at least one surface at least partially coated with the film-forming composition of claim 1.

38. A film-forming composition that is substantially free of organic solvent, comprising:
a resinous binder comprising an aqueous dispersion comprising polymeric microparticles that are adapted to react with a crosslinking agent;
at least one first water dilutable additive comprising the reaction product of (i) a reactant comprising at least one isocyanate functional group with (ii) an active hydrogen containing alkoxypolyalkylene compound; and
at least one second water dilutable additive that is different from the first water dilutable additive, wherein the second water dilutable additive comprises a reactive carboxylic acid functional group-containing polysiloxane.

39. The film-forming composition of claim 38, wherein the reactant (i) comprises a polyisocyanate selected from the group consisting of aliphatic polyisocyanates, cycloaliphatic polyisocyanates, aromatic polyisocyanates, and mixtures thereof.

40. The film-forming composition of claim 39, wherein the reactant (i) comprises a diisocyanate.

41. The film-forming composition of claim 38, wherein the reactant (ii) comprises an alkoxyethylene glycol.

42. The film-forming composition of claim 38, wherein the polymeric microparticles are prepared from (A) at least one polymer having reactive functional groups and (B) at least one crosslinking agent.

43. The film-forming composition of claim 38 further comprising at least one crosslinking agent that is adapted to be at least one of water soluble and water dispersable.

44. The film-forming composition of claim 38 further comprising an aqueous dispersion of polymeric microparticles prepared by emulsion polymerization of a monomeric composition comprising (1) at least 10 percent by weight of one or more vinyl aromatic compounds; (2) 0 to 10 percent by weight of one or more carboxylic acid functional polymerizable, ethylenically unsaturated monomers; (3) 0 to 10 percent by weight of one or more polymerizable monomers having one or more functional groups which are capable of reacting to form crosslinks; and (4) one or more polymerizable ethylenically unsaturated monomers, where the weight percentages are based on total weight of monomers present in the monomeric composition, and
wherein each of (1), (2), (3) and (4) above is different one from the other, and at least one of (3) and (4) is present in the monomeric composition.

45. A film-forming composition that is substantially free of organic solvent, comprising:
a resinous binder comprising an aqueous dispersion comprising polymeric microparticles that are adapted to react with a crosslinking agent;
at least one first water dilutable additive comprising the reaction product of (i) a reactant comprising at least one isocyanate functional group with (ii) an active hydrogen containing alkoxypolyalkylene compound;
at least one second water dilutable additive that is different from the first water dilutable additive, wherein the second water dilutable additive comprises a reactive carboxylic acid functional group-containing polysiloxane;
at least one crosslinking agent that is adapted to be at least one of water soluble and water dispersable; and
an aqueous dispersion polymeric microparticles prepared by emulsion polymerization of a monomeric composition comprising (1) at least 10 percent by weight of one or more vinyl aromatic compounds; (2) 0 to 10 percent by weight of one or more carboxylic acid functional polymerizable, ethylenically unsaturated monomers; (3) 0 to 10 percent by weight of one or more polymerizable monomers having one or more functional groups which are capable of reacting to form crosslinks; and (4) one or more polymerizable ethylenically unsaturated monomers, where the weight percentages are based on total weight of monomers present in the monomeric composition, and wherein each of (1), (2), (3) and (4) above is different one from the other, and at least one of (3) and (4) is present in the monomeric composition.

46. A multi-layer composite coating comprising a basecoat deposited from at least one basecoat film-forming composition and a topcoat composition applied over at least a portion of the basecoat in which the topcoat is deposited from at least one topcoat film-forming composition that is substantially free of organic solvent, the topcoat film-forming composition comprising:
a resinous binder; and
at least one first water dilutable additive comprising the reaction product of (i) a reactant comprising at least one isocyanate functional group with (ii) an active hydrogen containing alkoxypolyalkylene compound.

47. The multi-layer composite coating of claim 46, wherein the basecoat is deposited from at least one film-forming composition comprising at least one pigment.

48. The multi-layer composite coating of claim 46, wherein the topcoat is transparent.

49. A substrate having at least one surface at least partially coated with the multi-layer composite coating of claim 46.

50. The multi-layer composite coating of claim 46 wherein the reactant (i) comprises a polyisocyanate selected from the group consisting of aliphatic polyisocyanates, cycloaliphatic polyisocyanates, aromatic polyisocyanates, and mixtures thereof.

51. The multi-layer composite coating of claim 50, wherein the reactant (i) comprises a diisocyanate.

52. The multi-layer composite coating of claim 46, wherein the reactant (ii) comprises an alkoxyethylene glycol.

53. The multi-layer composite coating of claim 46, wherein the first water dilutable additive is present in the film-forming composition in an amount ranging from about 0.01 to about 10 percent by weight based upon the total weight of resin solids present in the film-forming composition.

54. The multi-layer composite coating of claim 46, wherein the topcoat film-forming composition further comprises at least one second water dilutable additive that is different from the first water dilutable additive, wherein the second water dilutable additive comprises a reactive functional group-containing polysiloxane.

55. The multi-layer composite coating of claim 54 wherein the second water dilutable additive comprising a reactive functional group-containing polysiloxane comprises a carboxylic acid functional group-containing polysiloxane.

56. The multi-layer composite coating of claim 54 wherein the second water dilutable additive comprising a reactive functional group-containing polysiloxane is present in the film forming composition in an amount ranging from 0.1 to 10.0 percent by weight based on the weight of total solids present in the film-forming composition.

57. The multi-layer composite coating of claim 46, wherein the resinous binder comprises (1) at least one reactive functional group-containing polymer and (2) at least one crosslinking agent having functional groups reactive with the functional groups of the polymer.

58. The multi-layer composite coating of claim 57, wherein the polymer (1) is selected from the group consisting of acrylic polymers, polyester polymers, polyurethane polymers, polyether polymers, polysiloxane polymers, polyepoxide polymers, copolymers thereof, and mixtures thereof.

59. The multi-layer composite coating of claim 57, wherein the polymer (1) contains functional groups selected from the group consisting of hydroxyl groups, carbamate groups, carboxyl groups, isocyanate groups, amino groups, amido groups, and combinations thereof.

60. The multi-layer composite coating of claim 46, wherein the resinous binder comprises an aqueous dispersion comprising polymeric microparticles that are adapted to react with a crosslinking agent.

61. The multi-layer composite coating of claim 60, wherein the polymeric microparticles are prepared from at least one polymer having reactive functional groups and at least one crosslinking agent.

62. The multi-layer composite coating of claim 61, wherein the polymer comprises a substantially hydrophobic polymer.

63. The multi-layer composite coating of claim 46, wherein the resinous binder comprises an aqueous dispersion of polymeric microparticles prepared from (1) one or more reaction products of ethylenically unsaturated monomers, at least one of which contains at least one acid functional group, (2) one or more polymers different from (1) and (3), and (3) one or more crosslinking agents having functional groups reactive with those of at least one of the reaction product (1) and the polymer (2).

64. The multi-layer composite coating of claim 63, wherein the polymer (2) comprises a substantially hydrophobic polymer and the crosslinking agent (3) comprises a substantially hydrophobic crosslinking agent.

65. The multi-layer composite coating of claim 46, wherein the resinous binder comprises an aqueous dispersion of polymeric microparticles prepared from (A) at least one functional group-containing reaction product of polymerizable, ethylenically unsaturated monomers; and (B) at least one reactive organopolysiloxane.

66. The multi-layer composite coating of claim 65, wherein the polymeric microparticles are also prepared from (C) at least one substantially hydrophobic crosslinking agent.

67. The multi-layer composite coating of claim 65, wherein (B) comprises at least one of the following structural unit:
R¹ₙR²ₘ—(—Si—O)_{(4-n-m)/2}
wherein m and n each represent a positive number fulfilling the requirements of: 0<n<4; 0<m<4; and 2≦(m+n)<4; R¹ represents H, OH or monovalent hydrocarbon groups; and R² represents a monovalent reactive functional group-containing organic moiety.

68. The multi-layer composite coating of claim 65, wherein the reactive organopolysiloxane is substantially hydrophobic.

69. The multi-layer composite coating of claim 46, wherein the topcoat film-forming composition further comprises at least one crosslinking agent that is adapted to be at least one of water soluble and water dispersible.

70. The multi-layer composite coating of claim 69, wherein the crosslinking agent that is adapted to be at least one of water soluble and water dispersible is selected from the group consisting of polyisocyanates, aminoplast resins, and mixtures thereof.

71. The multi-layer composite coating of claim 69, wherein the crosslinking agent that is adapted to be at least one of water soluble and water dispersible is present in the film-forming composition in an amount ranging from 0 to 70 percent by weight based on total weight of resin solids present in the composition.

72. The multi-layer composite coating of claim 46, further comprising an aqueous dispersion of polymeric microparticles prepared by emulsion polymerization of a monomeric composition comprising (1) at least 10 percent by weight of one or more vinyl aromatic compounds; (2) 0 to 10 percent by weight of one or more carboxylic acid functional polymerizable, ethylenically unsaturated monomers; (3) 0 to 10 percent by weight of one or more polymerizable monomers having one or more functional groups which are capable of reacting to form crosslinks; and (4) one or more polymerizable ethylenically-unsaturated monomers, where the weight percentages are based on total weight of monomers present in the monomeric composition, and
wherein each of (1), (2), (3) and (4) above is different one from the other, and at least one of (3) and (4) is present in the monomeric composition.

73. The multi-layer composite coating of claim 46, wherein the topcoat film-forming composition further comprises inorganic selected from fused silica, amorphous silica, colloidal silica, alumina, colloidal alumina, titanium dioxide, zirconia, colloidal zirconia and mixtures thereof.

74. The multi-layer composite coating of claim 73, wherein the inorganic particles have an average particle size ranging from 1 to 1000 nanometers prior to incorporation into the topcoat film-forming composition.

75. The multi-layer composite coating of claim 73, wherein the inorganic particles hvae an average particle size ranging from 1 to 10 microns prior to incorporation into the topcoat film-forming composition.

76. A method of applying a multi-layer composite coating to a substrate comprising the following steps:
(a) applying to a substrate a film-forming composition from which a basecoat is deposited onto the substrate; and
(b) applying onto at least a portion of the basecoat a film-forming composition that is substantially free of organic solvent from which a topcoat is deposited over the basecoat, the film-forming composition that is substantially free of organic solvent comprising:
a resinous binder; and
at least one water first dilutable additive comprising the reaction product of (i) a reactant comprising at least one isocyanate functional group with (ii) an active hydrogen containing alkoxypolyalkylene compound.

77. The method of claim 76, wherein the basecoat is deposited from at least one film-forming composition comprising at least one pigment.

78. The method of claim 76, wherein the topcoat is transparent.

79. The method of claim 76 wherein the reactant (i) comprises a polyisocyanate selected from the group consisting of aliphatic polyisocyanates, cycloaliphatic polyisocyanates, aromatic polyisocyanates, and mixtures thereof.

80. The method of claim 79, wherein the reactant (i) comprises a diisocyanate.

81. The method of claim 76, wherein the reactant (ii) comprises an alkoxyethylene glycol.

82. The method of claim 76, wherein the first water dilutable additive is present in the film-forming composition in an amount ranging from about 0.01 to about 10 percent by weight based upon the total weight of resin solids present in the film-forming composition.

83. The method of claim 76, wherein the film-forming composition that is substantially free of organic solvent further comprises at least one second water dilutable additive that is different from the first water dilutable additive, wherein the second water dilutable additive comprises a reactive functional group-containing polysiloxane.

84. The method of claim 83, wherein the second water dilutable additive comprising a reactive functional group-containing polysiloxane comprises a carboxylic acid functional group-containing polysiloxane.

85. The method of claim 83 wherein the second water dilutable additive comprising a reactive functional group-containing polysiloxane is present in the film forming composition in an amount ranging from 0.1 to 10.0 weight percent based on the total weight of resin solids present in the film-forming composition.

86. The method of claim 76, wherein the resinous binder comprises (1) at least one reactive functional group-containing polymer and (2) at least one crosslinking agent having functional groups reactive with the functional groups of the polymer.

87. The method of claim 86, wherein the polymer (1) is selected from the group consisting of acrylic polymers, polyester polymers, polyurethane polymers, polyether polymers, polysiloxane polymers, polyepoxide polymers, copolymers thereof, and mixtures thereof.

88. The method of claim 87, wherein the polymer (1) contains functional groups selected from the group consisting of hydroxyl groups, carbamate groups, carboxyl groups, isocyanate groups, amino groups, amido groups, and combinations thereof.

89. The method of claim 76, wherein the resinous binder comprises an aqueous dispersion comprising polymeric microparticles that are adapted to react with a crosslinking agent.

90. The method of claim 89, wherein the polymeric microparticles are prepared from at least one polymer-having reactive functional groups and at least one crosslinking agent.

91. The method of claim 90, wherein the polymer comprises a substantially hydrophobic polymer.

92. The method of claim 76, wherein the resinous binder comprises an aqueous dispersion of polymeric microparticles prepared from (1) one or more reaction products of ethylenically unsaturated monomers, at least one of which contains at least one acid functional group, (2) one or more polymers different from (1) and (3), and (3) one or more crosslinking agents having functional groups reactive with those of at least one of the reaction product (1) and the polymer (2).

93. The method of claim 92, wherein the polymer (2) comprises a substantially hydrophobic polymer and the crosslinking agent (3) comprises a substantially hydrophobic crosslinking agent.

94. The method of claim 76, wherein the resinous binder comprises an aqueous dispersion of polymeric microparticles prepared from (A) at least one functional group-containing reaction product of polymerizable, ethylenically unsaturated monomers; and (B) at least one reactive organopolysiloxane.

95. The method of claim 94, wherein the polymeric microparticles are also prepared from (C) at least one substantially hydrophobic crosslinking agent.

96. The method of claim 94, wherein (B) comprises at least one of the following structural unit:
R¹ₙR²ₘ—(—Si—O)_{(4-n-m)/2}
wherein m and n each represent a positive number fulfilling the requirements of: 0<n<4; 0<m<4; and 2≦(m+n)<4; R¹ represents H, OH or monovalent hydrocarbon groups; and R² represents a monovalent reactive functional group-containing organic moiety.

97. The method of claim 94, wherein the reactive organopolysiloxane is substantially hydrophobic.

98. The method of claim 76, wherein the film-forming composition that is substantially free of organic solvent further comprises at least one crosslinking agent that is adapted to be at least one of water soluble and water dispersible.

99. The method of claim 98, wherein the crosslinking agent that is adapted to be at least one of water soluble and water dispersible is selected from the group, consisting of hydrophilically modified polyisocyanates, aminoplast resins, and mixtures thereof.

100. The method of claim 98, wherein the crosslinking agent that is adapted to be at least one of water soluble and water dispersible is present in the film-forming composition that is substantially-free of organic solvent in an amount ranging from 0 to 70 percent by weight based on total weight of resin solids present in the composition.

101. The method of claim 76, wherein the film-forming composition that is substantially free of organic solvent further comprises an aqueous dispersion of polymeric microparticles prepared by emulsion polymerization of a monomeric composition comprising (1) at least 10 percent by weight of one or more vinyl aromatic compounds; (2) 0 to 10 percent by weight of one or more carboxylic acid functional polymerizable, ethylenically unsaturated monomers; (3) 0 to 10 percent by weight of one or more polymerizable monomers having one or more functional groups which are capable of reacting to form crosslinks; and (4) one or more polymerizable ethylenically unsaturated monomers, where the weight percentages are based on total weight of monomers present in the monomeric composition, and
wherein each of (1), (2), (3) and (4) above is different one from the other, and at least one of (3) and (4) is present in the monomeric composition.

102. The method of claim 76, wherein the film-forming composition that is substantially free of organic solvent further comprises inorganic particles selected from fused silica, amorphous silica, colloidal silica, alumina, colloidal alumina, titanium dioxide, zirconia, colloidal zirconia and mixtures thereof.
